(19) United States
(12) Patent Application Publication
(10) Pub. No.: US 2020/0238483 A1
(43) Pub. Date: Jul. 30, 2020

(54) POWER TOOL

(71) Applicant: MAKITA CORPORATION, Anjo-shi (JP)

(72) Inventor: Takeshi KAMIYA, Anjo-shi (JP)

(73) Assignee: MAKITA CORPORATION, Anjo-shi (JP)

(21) Appl. No.: 16/728,094

(22) Filed: Dec. 27, 2019

(30) Foreign Application Priority Data
Jan. 28, 2019 (JP) 2019-012418

(51) Int. Cl. B25B 21/02

(52) U.S. Cl. CPC B25B 21/026; B25D 16/003; B25B 21/023

(57) ABSTRACT

A power tool allows mode switching and clutch operation torque switching using a single ring. An electric vibration driver drill includes an internal gear that meshes with planetary gears, an internal gear lock pin that moves forward relative to the internal gear to lock the internal gear, a first vibration cam fixed to a spindle, a second vibration cam that rubs against the first vibration cam and rotate relative to a gear housing, a vibration switch lever that moves forward relative to the second vibration cam to lock the second vibration cam in a nonrotatable manner, and an annular change ring that switches between forward movement and rearward movement of the internal gear lock pins and switches between forward movement and rearward movement of the vibration switch lever.

### CROSS-REFERENCE TO RELATED APPLICATIONS

This application claims the benefit of priority to Japanese Patent Application No. 2019-012418, filed on Jan. 28, 2019, the entire contents of which are hereby incorporated by reference.

### BACKGROUND

### 1. Technical Field

The present invention relates to a power tool such as an electric vibration driver drill or an electric vibration drill.

### 2. Description of the Background

A known electric vibration driver drill includes a mode change ring 82 and a change ring 86, as described in Japanese Unexamined Patent Application Publication No. 2017-100259.

The mode change ring 82 switches between a drill mode, a clutch mode, and a vibration mode by changing its rotational position. In the drill mode, a clutch and a vibration mechanism do not operate. In the clutch mode, the clutch operates, but the vibration mechanism does not operate. In the vibration mode, the clutch does not operate, but the vibration mechanism operates.

The change ring 86 switches the torque for operating the clutch by changing its rotational position.

### BRIEF SUMMARY

One or more aspects of the present invention are directed to a power tool that allows mode switching and clutch operation torque switching with a single ring.

A first aspect of the present invention provides a power tool, including:

a motor;

a sun gear driven by the motor;

a planetary gear driven by the sun gear;

an internal gear meshing with the planetary gear;

an internal gear lock pin movable forward and rearward relative to the internal gear and configured to lock the internal gear in a nonrotatable manner at a forward position;

a spindle driven by the planetary gear;

a gear housing accommodating the planetary gear;

a first vibration cam fixed to the spindle;

a second vibration cam configured to rub against the first vibration cam and rotatable relative to the gear housing;

a vibration switch member movable forward and rearward relative to the second vibration cam and configured to lock the second vibration cam in a nonrotatable manner at a forward position; and

an annular change ring configured to switch between forward movement and rearward movement of the internal gear lock pin and to switch between forward movement and rearward movement of the vibration switch member.

A second aspect of the present invention provides a power tool, including:

a motor;

a sun gear driven by the motor;

a planetary gear driven by the sun gear;

an internal gear meshing with the planetary gear;

a clutch pin elastic member;

a clutch pin configured to come in contact with the internal gear when urged by the clutch pin elastic member to retain the internal gear in a nonrotatable manner in accordance with an urging force of the clutch pin elastic member;

an elastic member holder holding the clutch pin elastic member to allow the clutch pin elastic member to generate a variable urging force;

a spindle driven by the planetary gear;

a gear housing accommodating the planetary gear;

a first vibration cam fixed to the spindle;

a second vibration cam configured to rub against the first vibration cam and rotatable relative to the gear housing;

a vibration switch member movable forward and rearward relative to the second vibration cam and configured to lock the second vibration cam in a nonrotatable manner at a forward position; and

an annular change ring configured to switch the urging force of the clutch pin elastic member held by the elastic member holder and to switch between forward movement and rearward movement of the vibration switch member.

A third aspect of the present invention provides a power tool, including:

a sun gear;

a planetary gear meshing with the sun gear;

an internal gear meshing with the planetary gear;

a spindle connected to the planetary gear;

an elastic member configured to urge the internal gear;

vibration cams configured to axially vibrate the spindle;

an internal gear lock pin configured to lock the internal gear in a nonrotatable manner; and

a change ring connected to the elastic member, the vibration cams, and the internal gear lock pin.

The power tool according to the above aspects allows mode switching and clutch operation torque switching with the single ring.

### BRIEF DESCRIPTION OF DRAWINGS

FIG. 1 is a longitudinal central sectional view of an electric vibration driver drill according to an embodiment of the present invention.

FIG. 2 is a front view of an upper portion in FIG. 1.

FIG. 3 is a rear view of the electric vibration driver drill in FIG. 1.

FIG. 4 is a cross-sectional view taken along line A-A in FIG. 1.

FIG. 5 is a right view of a gear assembly in the electric vibration driver drill shown in FIG. 1.

FIG. 6 is a front view of the gear assembly in FIG. 5.

FIG. 7 is a rear view of the gear assembly in FIG. 5.

FIG. 8 is a longitudinal central sectional view of the gear assembly in FIG. 5.

FIG. 9 is a cross-sectional view taken along line B-B in FIG. 6.

FIG. 10A is a cross-sectional view taken along line C-C in FIG. 8, and FIG. 10B is a cross-sectional view taken along line G-G in FIG. 10A.

FIG. 11 is a cross-sectional view taken along line D-D in FIG. 8.

FIG. 12 is a cross-sectional view taken along line E-E in FIG. 8.

FIG. 13 is a cross-sectional view taken along line F-F in FIG. 8.

FIG. 14 is an exploded perspective view of a rear portion of the gear assembly shown in FIG. 5.

FIG. 15 is an exploded perspective view of a front portion of the gear assembly shown in FIG. 5.

FIG. 16A is a diagram showing a left portion similar to FIG. 10A in a vibration drill mode,

FIG. 16B is a cross-sectional view taken along line H-H in FIG. 16A, and FIG. 16C is an exploded perspective view of the front portion of the gear assembly shown in FIG. 5 excluding a change ring, a clutch switch ring, and a spring holder.

FIGS. 17A to 17C are diagrams similar to FIGS. 16A to 16C in a drill mode.

FIGS. 18A to 18C are diagrams similar to FIGS. 16A to 16C in an intermediate state between the drill mode and a clutch mode (with a maximum clutch setting).

FIGS. 19A to 19C are diagrams similar to FIGS. 16A to 16C in a state between the drill mode and the clutch mode (with a maximum clutch setting) immediately before a lock lever is disengaged.

FIGS. 20A to 20C are diagrams similar to FIGS. 16A to 16C in the clutch mode (with a maximum clutch setting).

FIGS. 21A to 21C are diagrams similar to FIGS. 16A to 16C in an intermediate state between the clutch mode (with a maximum clutch setting) and the drill mode, and FIG. 21D is an enlarged view of an area I shown in FIG. 21A.

### DETAILED DESCRIPTION

Embodiments and modifications of the present invention will now be described below with reference to the drawings as appropriate.

The directional terms such as front, rear, up, down, right, and left in the embodiments and the modifications are defined for ease of explanation, and may be changed depending on, for example, at least the operating situations or the status of a movable member.

The present invention is not limited to the embodiments and modifications described below.

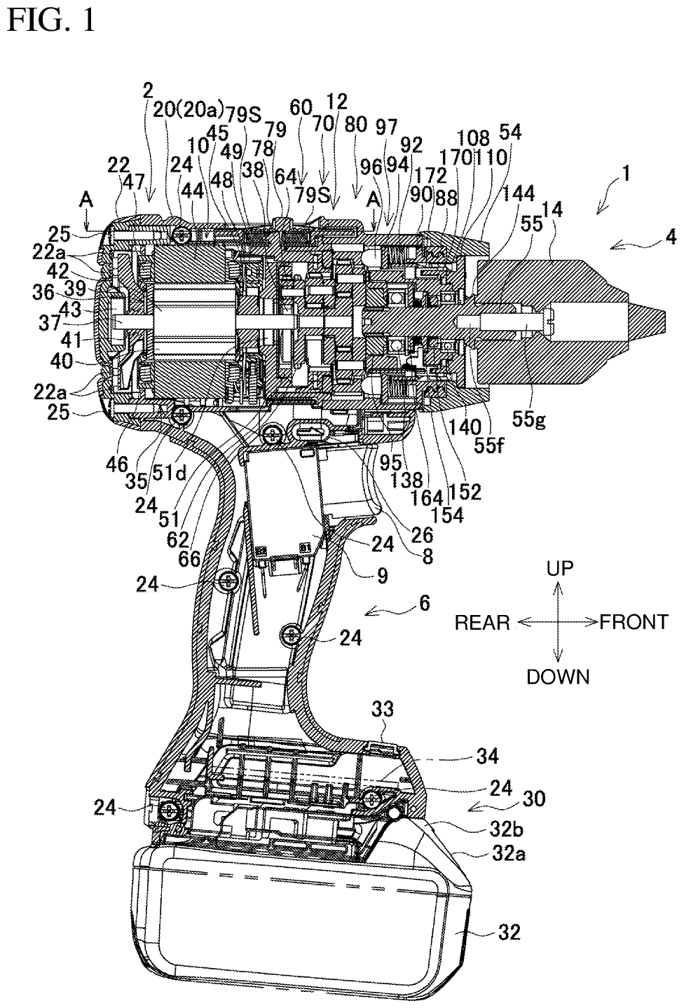

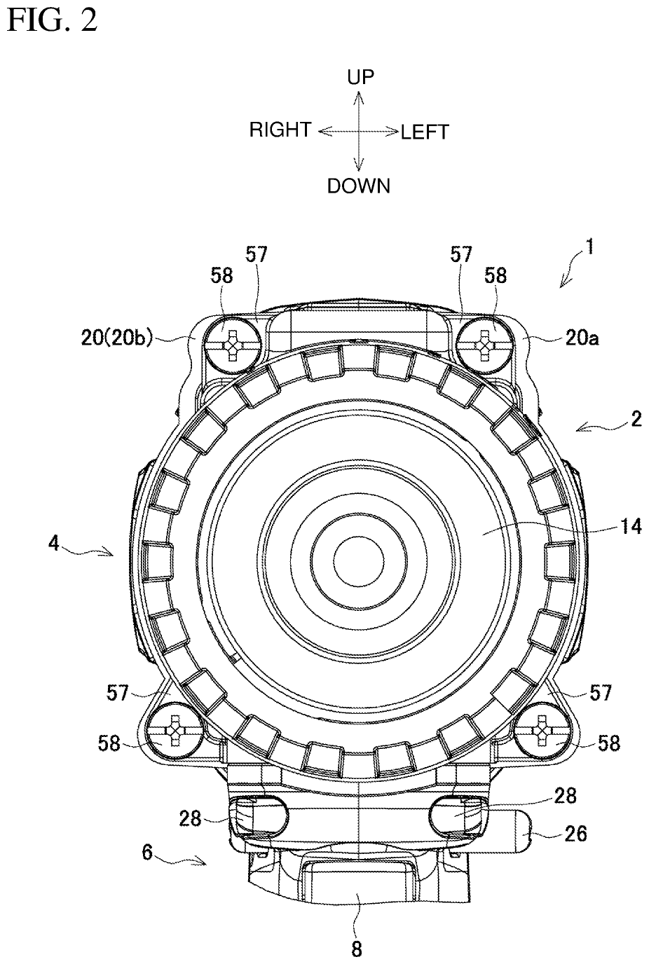

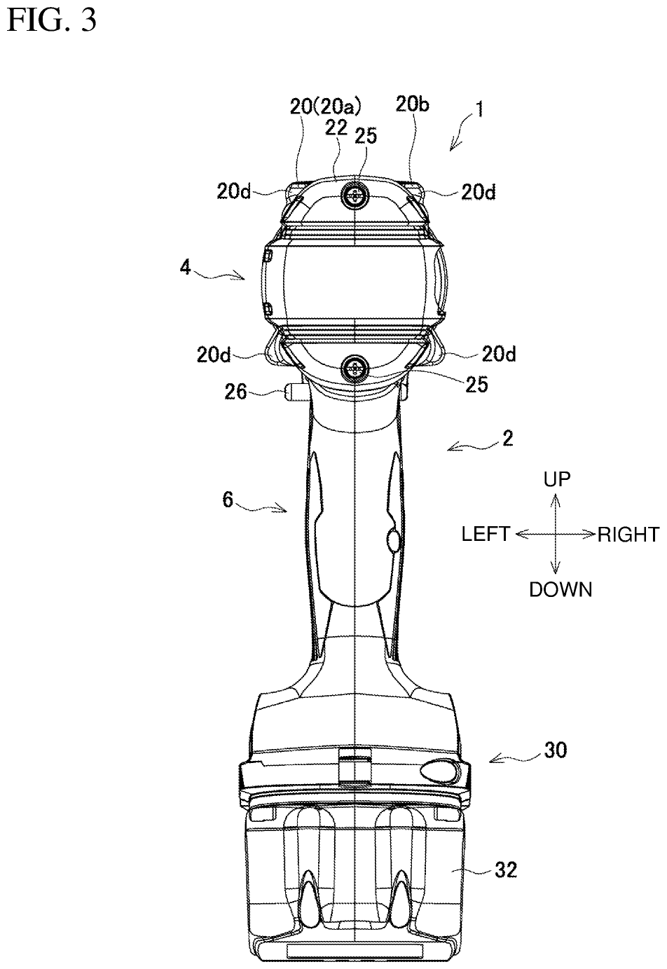

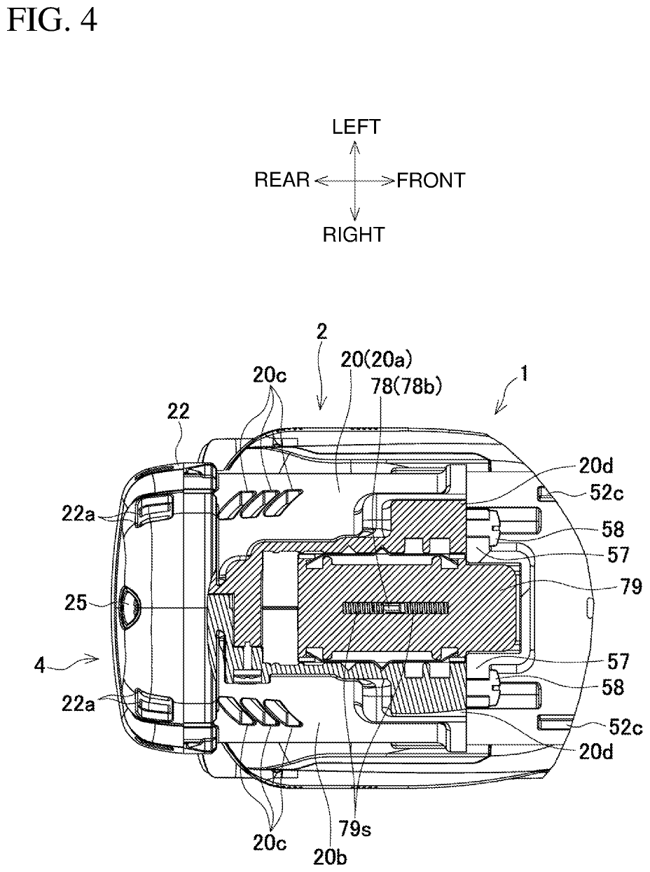

FIG. 1 is a longitudinal central sectional view of an electric vibration driver drill 1 as an example of a power tool. FIG. 2 is a front view of an upper portion of the electric vibration driver drill 1. FIG. 3 is a rear view of the electric vibration driver drill 1. FIG. 4 is a cross-sectional view taken along line A-A in FIG. 1.

The electric vibration driver drill (vibration driver drill, hammer driver drill, percussion driver) 1 includes a housing 2. The housing 2 defines an outer wall (frame) of the vibration driver drill 1.

The vibration driver drill 1 includes a body 4 and a grip 6. The body 4 is cylindrical, and has the central axis extending in the front-rear direction. The grip 6 protrudes downward from a lower portion of the body 4.

The grip 6 is gripped by a user. The grip 6 includes a trigger switch lever 8 at its upper end. The switch lever 8 is pulled with a fingertip of the user. The switch lever 8 protrudes from a switch body 9 (refer to FIG. 1).

As shown in FIG. 1, the body 4 accommodates a motor 10 in its rear portion. A gear assembly 12 is located in front of the motor 10. A chuck 14 for holding a bit (tip tool) is located in front of the gear assembly 12.

The motor 10 is a driving source of the vibration driver drill 1. The rotation of the motor 10 is reduced by the gear assembly 12, and the rotation is transmitted to the chuck 14 and to the bit.

The housing 2 includes a body housing 20 and a rear cover 22. The body housing 20 is formed from a resin, and holds the motor 10, the switch body 9, and other components. The rear cover 22 is formed from a resin, and covers the rear portion of the motor 10.

The body housing 20 includes an outer wall of the grip 6.

The body housing 20 includes a halved left body housing 20a and a halved right body housing 20b. The left body housing 20a has multiple screw bosses. The right body housing 20b has screw holes corresponding to the screw bosses. The left body housing 20a and the right body housing 20b are joined with multiple screws 24 extending in the lateral direction in the screw bosses and the screw holes, and inserted from the right.

The rear portions of the left body housing 20a and the right body housing 20b fit together to define an opening. The rear cover 22 is fixed to the left body housing 20a and/or the right body housing 20b with multiple screws 25 extending in the front-rear direction to cover the opening. The screws 25 are each located on the upper or lower end of the rear cover 22 to fasten the rear cover 22 reliably.

The left body housing 20a and the right body housing 20b have multiple air inlets 20c on the upper and lower side surfaces in the rear end portions. Each air inlet 20c extends vertically. The air inlets 20c are located in the front-rear direction (refer to FIG. 4). The air inlets 20c are thus sequential slits arranged along an area in front of and adjacent to the rear cover 22. Multiple air outlets 22a are located behind the air inlets 20c on the side surfaces of the rear cover 22. Each air outlet 22a extends in the front-rear direction. The air outlets 22a are located vertically (refer to FIGS. 1 and 4).

A forward-reverse switch lever 26 is located behind the switch lever 8. The forward-reverse switch lever 26 is used to switch the rotation direction of the motor 10. The forward-reverse switch lever 26 is placed through a boundary area between the body 4 and the grip 6 in the lateral direction.

Above the switch lever 8, multiple (two) light sources 28 are located in front of the forward-reverse switch lever 26. The light sources 28 can illuminate the front. The light sources 28 are located in the lateral direction. The light sources 28 are, for example, light-emitting diodes (LEDs).

The grip 6 includes a battery mount 30 at its lower end. The battery mount 30 is flared outward with respect to the upper portion. A battery 32 is held below the battery mount 30. The battery 32 is detachable using a battery button 32a. The battery 32, which is for example a lithium-ion battery, contains multiple cells (not shown). The cells are axially elongated columns facing in the lateral direction.

The battery mount 30 includes a display 33 in its front upper portion (the front upper surface of the flared lower portion of the grip 6). The display 33 displays the status of electronic gears by illuminating multiple lamps.

The battery 32 is attached by sliding the battery 32 from the front to the rear of the battery mount 30 with a battery terminal facing upward and a raised portion 32b facing upward and frontward. When the battery 32 is attached, the rear of the raised portion 32b comes in contact with the front of the battery mount 30, and the battery terminal comes in contact with a battery mount terminal in the battery mount 30. During the attachment, a battery tab urged upward by an elastic member and protruding from the upper surface near the front portion of the battery 32 is fitted into a battery mount recess that is an upward recess in the lower front of the battery mount 30. In contrast, the battery 32 is removed by operating the battery button 32a connected to the battery tab. This allows forward sliding of the battery 32 with the battery tab disengaged from the battery mount recess.

As shown in FIG. 1, the battery mount 30 holds a control circuit board 34 included in a controller for controlling a motor. The control circuit board 34 includes a columnar capacitor (not shown) protruding upward from other components and a microcomputer (not shown). The control circuit board 34 is electrically connected to the motor 10 with a power lead wire and a signal lead wire (not shown). The control circuit board 34 is electrically connected to the battery mount terminal in the battery mount 30 and the switch body 9. The control circuit board 34 is electrically connected to the display 33, and controls, for example, information appearing on the display 33.

As shown in FIG. 1, the motor 10 is a brushless motor, and includes a cylindrical stator 35 and a rotor 36. The rotor 36 is located inward from the stator 35.

The rotor 36 includes a motor shaft 37, a pinion 38, a rotor core 39, and a permanent magnet 40. The motor shaft 37 is columnar, and extends in the front-rear direction. The pinion 38 is integral with the front end of the motor shaft 37. The rotor core 39 is cylindrical, and surrounds the middle portion of the motor shaft 37. The permanent magnet 40 is placed inside the rotor core 39.

A cooling fan 42 is attached behind the motor shaft 37 via a metal insert bush 41. The fan 42 is a centrifugal fan. The insert bush 41 is press-fitted onto the motor shaft 37 and fastened firmly. Thus, the fan 42 fastened to the insert bush 41 is less likely to rotate relative to the motor shaft 37.

The air outlets 22a are located radially outward from the fan 42.

A motor rear bearing 43 is held behind the fan 42 and on the inner surface of the rear of the rear cover 22. The motor rear bearing 43 supports the rear end of the motor shaft 37 in a rotatable manner.

The stator 35 includes a stator core 44, a front insulator 45, a rear insulator 46, a coil 47, a sensor board 48, and a metal plate 49. The stator core 44 includes multiple teeth and a cylindrical portion having an axis extending in the front-rear direction. The teeth protrude radially inward from the inner surface of the cylindrical portion. The front insulator 45 and the rear insulator 46 are ring-shaped. The front insulator 45 is attached to the front end of the stator core 44, and the rear insulator 46 is attached to the rear end of the stator core 44. The coil 47 is wound around the teeth via the front insulator 45 and the rear insulator 46. The sensor board 48 is attached in front of the front insulator 45. The metal plate 49 is formed from a synthetic resin. The metal plate 49 is annular and includes multiple arc-shaped metal sheets. The metal plate 49 is attached in front of the sensor board 48.

The sensor board 48 detects the rotational position of the rotor 36 (permanent magnet 40) and transmits the information to the control circuit board 34.

The metal sheets of the metal plate 49 electrically connect the coils 47 to each other in a predetermined manner. The metal sheets of the metal plate 49 are connected to the power lead wire connected to the control circuit board 34.

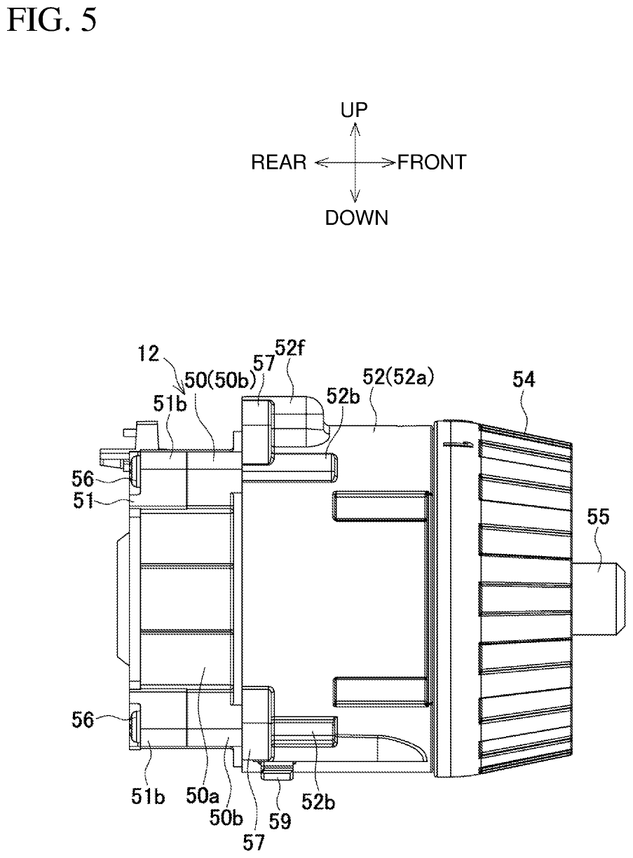

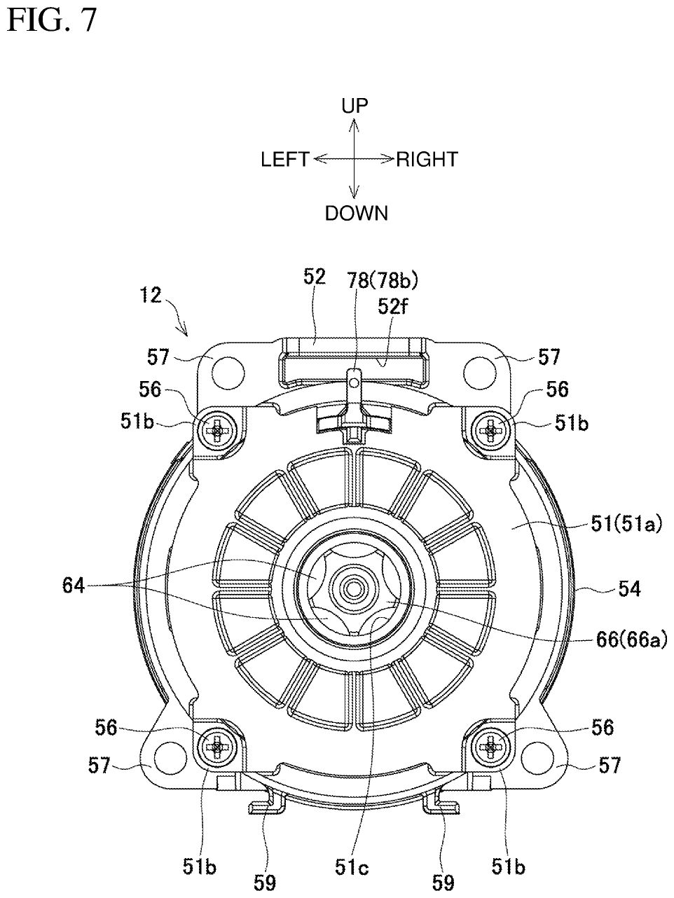

As shown in FIGS. 5 to 15, the gear assembly 12 includes a gear case 50, a motor bracket 51, a gear housing 52, and a change ring 54. The gear case 50 is cylindrical, and defines an outer wall of the gear assembly 12. The motor bracket 51 is plate-like (dish-shaped), and is located behind the rear end of the gear case 50. The gear housing 52 is formed from a metal. The gear housing 52 is a double cylinder including inner and outer portions. The gear housing 52 is located in front of the gear case 50. The change ring 54 is located in front of the gear housing 52, and is exposed on the upper front of the housing 2. The change ring 54 is used for mode switching, and is externally mounted on the housing 2.

A spindle 55 is located radially inside a front portion of an outer wall of the gear assembly 12. The spindle 55 extends along the central axis of the gear assembly 12. The spindle 55 has a front end protruding frontward from an outer wall of the gear assembly 12.

The spindle 55 is a column having an axis extending in the front-rear direction. The spindle 55 includes a spindle flange 55a, a front step 55b, a middle step 55c, a rear step 55d, a clip groove 55e, and a spindle hole 55f. The spindle flange 55a widens radially outward from its middle portion in the front-rear direction. The front step 55b, the middle step 55c, and the rear step 55d are located behind the spindle flange 55a and each have a smaller diameter than the step located forward. The clip groove 55e extends circumferentially in the front of the middle step 55c. The spindle hole 55f extends in the front-rear direction in a front central portion of the spindle 55, and has a front end opening. The spindle hole 55f is a bolt hole having a threaded groove. An external thread (not shown) are formed on the outer surface of the spindle 55 radially outward of the spindle hole 55f.

The chuck 14 has an internal thread (not shown) corresponding to the external thread on the spindle 55. The internal thread on the chuck 14 receives the external thread on the spindle 55, and the spindle hole 55f receives a bolt 55g. This fastens the chuck 14 to the spindle 55. At least one of the spindle 55 and the chuck 14 serves as an output shaft.

The gear case 50 includes a cylindrical gear case base 50a. The gear case base 50a has screw hole portions 50b at its upper right, lower right, upper left, and lower left ends. The screw hole portions 50b each have a screw hole at the center of a tab piece protruding radially outward. The motor bracket 51 includes a motor bracket base 51a, which is a cylinder with a bottom. The motor bracket base 51a includes screw hole portions 51b. Screw holes 52b are formed at the rear of an outer cylinder 52a of the gear housing 52. The screw hole portions 51b protrude radially outward and further frontward. The screw holes 52b protrude radially outward. A screw 56 extends through the upper right screw hole portions 50b and 51b and the screw hole 52b. Screws 56 also extend through the lower right, upper left, and lower left screw hole portions 50b and 51b and screw holes 52b as well. In this manner, the gear case 50 and the gear housing 52 (and the motor bracket 51) are fastened together with a common connector (screws). This improves the degree of contact between components and protects the inner mechanism, and may prevent leakage of grease used in the inner mechanism. The gear assembly 12 is more compact than when connectors are provided separately for connecting the motor bracket 51 and the gear case 50 and for connecting the gear case 50 and the gear housing 52.

A side handle (not shown) is attachable to the outer cylinder 52a in the gear housing 52.

The gear assembly 12 is attached in front of the opening in the body housing 20 with screws 58. The screws 58 are placed through screw hole portions 57 located radially outward from the screw holes 52b in the gear housing 52, and are screwed into screw hole portions 20d having screw holes in the opening in the body 4. The lateral distance between the two upper screw hole portions 57 is smaller than between the two lower screw hole portions 57. The screw hole portions 57 are located in correspondence with the shape of the columnar body 4, under which the grip 6 extends. The upper portion of the body 4 is thus laterally compact.

The outer cylinder 52a in the gear housing 52 has tab members 59 on its right rear and left rear on the lower surface. The tab members 59 protrude downward and laterally outward. Each tab member 59 is engaged with the inner surface of the body housing 20 to prevent the gear assembly 12 and the body housing 20 from being separated.

The gear housing 52 has front, side, and upper portions exposed to define a portion of an outer wall of the body 4. The gear housing 52 is a part of the housing 2.

The motor bracket 51 has a center hole 51c for receiving a motor front bearing 51d. The motor front bearing 51d supports a front end of the motor shaft 37 (a rear side of the pinion 38) in a rotatable manner.

At least one of the motor bracket 51, the change ring 54, and the spindle 55 may not be a component of the gear assembly 12. The motor bracket 51 may be a component of the motor 10. Also, at least one of the chuck 14, the motor front bearing 51d, and the pinion 38 may be a component of the gear assembly 12.

The gear assembly 12 contains a planetary gear mechanism with three stages. The gear assembly 12 reduces the rotation of the motor shaft 37 and transmits the rotation to the spindle 55. The gear assembly 12 includes a rear planetary gear mechanism 60 (first reduction mechanism), a middle planetary gear mechanism 70 (second reduction mechanism), and a front planetary gear mechanism 80 (third reduction mechanism).

The rear planetary gear mechanism 60 includes an internal gear 62, multiple (five) planetary gears 64, and a carrier 66. The internal gear 62 is fixed inside the gear case 50. The planetary gears 64 include external teeth meshing with internal teeth on the internal gear 62. The carrier 66 supports the planetary gears 64 via needle bearings 65 in a rotatable manner.

The internal gear 62 is locked in a nonrotatable manner, with multiple (four) projections 62b fitted into multiple slits 51e. The projections 62b protrude radially outward from a ring-shaped internal teeth portion 62a. The slits 51e are formed on the cylindrical surface of the motor bracket base 51a and extend in the front-rear direction.

The planetary gears 64 mesh with the pinion 38 on the motor shaft 37.

The carrier 66 includes five pins 66b. The five pins 66b protrude rearward at circumferentially equal intervals from the rear surface of a disk member 66a having a center hole. Each pin 66b supports a single planetary gear 64 and a single needle bearing 65. The carrier 66 includes an external gear 66c. The external gear 66c cylindrically protrudes frontward from the front center of the disk member 66a. The disk member 66a includes meshing teeth 66d on its outer front surface.

The planetary gears 64 are supported by the needle bearing 65, and thus are supported more firmly than a ball bearing. The planetary gears 64 with smaller thicknesses in the axial direction (front-rear direction) achieve substantially the same strength as a ball bearing, thus downsizing not only the planetary gears 64 and the rear planetary gear mechanism 60, but also the vibration driver drill 1 in the front-rear direction.

A washer 68 is located between the planetary gears 64 and the motor bracket 51.

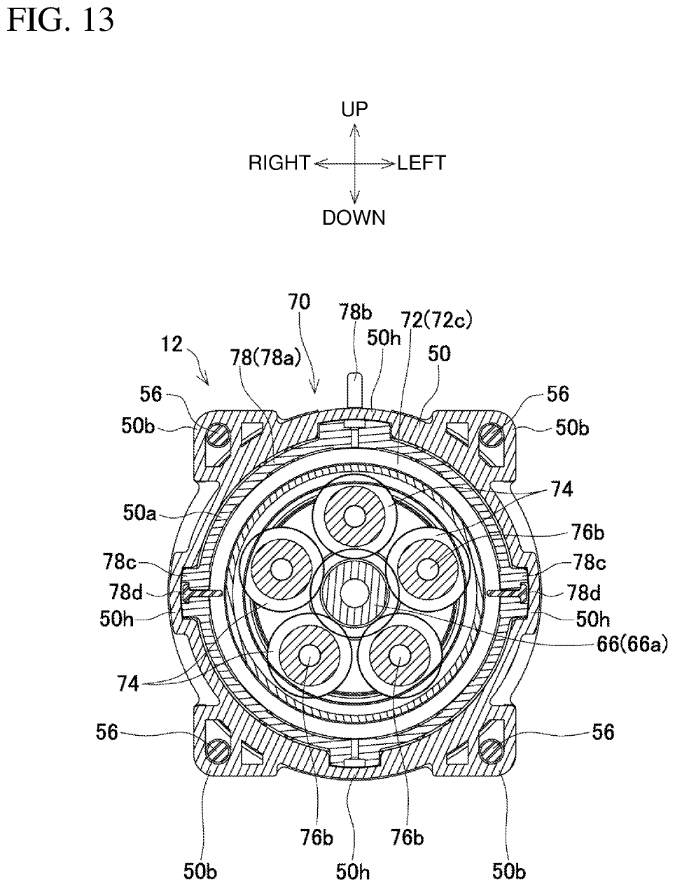

As also shown in FIG. 13, the middle planetary gear mechanism 70 includes an internal gear 72, multiple (five) planetary gears 74, and a carrier 76. The planetary gears 74 include external teeth meshing with internal teeth on the internal gear 72. The carrier 76 supports the planetary gears 74 in a rotatable manner.

A ring-shaped internal teeth portion 72a of the internal gear 72 has, on its outer front surface, multiple external teeth 72b arranged at circumferentially predetermined intervals. The external teeth 72b protrude in the radial direction and extend in the front-rear direction. The internal teeth portion 72a has, on its outer rear surface, a connection groove 72c extending circumferentially. The internal gear 72 includes meshing teeth 72d near its opening on the rear surface. The meshing teeth 72d are meshable with the meshing teeth 66d on the first carrier 66.

The planetary gears 74 mesh with the external gear 66c of the first carrier 66.

The carrier 76 includes five pins 76b. The pins 76b protrude rearward from the rear surface of a disk member 76a having a center hole. Each pin 76b supports a single planetary gear 74. The carrier 76 includes an external gear 76c (sun gear). The external gear 76c cylindrically protrudes frontward from the front center of the disk member 76a.

A connection ring 77 is located outside and in front of the internal gear 72. The connection ring 77 is held in the rear portion of the gear housing 52. An annular connection ring base 77a of the connection ring 77 includes as many internal teeth 77b as the external teeth 72b on its inner circumferential surface. The internal teeth 77b protrude radially inward and extend in the front-rear direction. The connection ring base 77a includes multiple (six) ridges 77c at circumferentially predetermined intervals on its outer circumferential surface. The ridges 77c protrude outward and extend in the front-rear direction. Each external tooth 72b enters between two of the internal teeth 77b.

The gear case base 50a has, on its front end, multiple arc ribs 50e at circumferentially equal intervals. The outer cylinder 52a in the gear housing 52 has, on its inner rear surface at the rear end, inner grooves (not shown) extending in the front-rear direction and receding radially outward. The connection ring 77 is locked in a nonrotatable manner, with the ridges 77c each received in a space between the corresponding arc ribs 50e and received in the corresponding inner groove on the outer cylinder 52a in the gear housing 52. The space between the arc ribs 50e is continuous with the inner groove on the outer cylinder 52a in the front-rear direction. The lower arc rib 50e has, on its radially outer surface, a protrusion 50f protruding radially outward. The protrusion 50f is received in a lower inner groove (not shown) extending in the front-rear direction and receding radially outward on the inner rear surface of the outer cylinder 52a in the gear housing 52.

As shown in FIG. 13, a speed switch ring 78 is located outside and behind the internal gear 72. The speed switch ring 78 includes an annular speed switch ring base 78a. The speed switch ring base 78a has, in its upper portion, an L-shaped connector 78b protruding rearward and upward. The speed switch ring base 78a has protruding pieces 78c protruding radially outward and rearward from its left, right, and bottom portions.

The gear case 50 has a slit 50g extending frontward from its upper rear. The slit 50g receives a lower end of the upper protrusion on the connector 78b. The upper portion of the upper protrusion on the connector 78b is connected to the lower portion of a speed switch lever 79 (refer to FIGS. 1 and 4) with coil springs 79S. The speed switch lever 79 is slidable forward and rearward in an upper portion of the housing 2. The coil springs 79S are elastic members aligned with each other in the front-rear direction. A front portion of the speed switch lever 79 is received in a hole 52f extending frontward from an upper rear end of the outer cylinder 52a. The screw hole portions 57 are located on the right and left of the hole 52f.

As shown in FIG. 13, the gear case base 50a has, on its inner surface, guide grooves 50h extending in the front-rear direction. Each guide groove 50h receives the corresponding protruding piece 78c. The guide grooves 50h receiving the corresponding protruding pieces 78c support the speed switch ring 78 in a movable manner in the front-rear direction alone.

Two pins 78d extend radially inward from outside in the left and right protruding pieces 78c. The outer head of each pin 78d comes in contact with the outer surface of the left or right protruding piece 78c. The inner tip of each pin 78d smaller than the head protrudes radially inward from the inner surface of each protruding piece 78c and is received in the connection groove 72c.

The speed switch lever 79 is moved forward (as shown in FIG. 1) to move the speed switch ring 78 forward with the connector 78b. The internal gear 72 then moves forward with the pins 78d and the connection groove 72c, while remaining meshed with the planetary gears 74. Each external tooth 72b thus enters between the internal teeth 77b on the connection ring 77 to regulate the rotation of the internal gear 72 in the circumferential direction. The planetary gears 74 revolve about the locked internal gear 72, transmitting rotation slower than the rotation of the first external gear 66c to the external gear 76c of the carrier 76. More specifically, the speed switch lever 79 is operated forward to enable a low speed mode in which the second middle planetary gear mechanism 70 performs speed reduction.

The speed switch lever 79 is operated rearward to move the speed switch ring 78 rearward. The internal gear 72 thus moves rearward, while remaining meshed with the planetary gears 74. Each external tooth 72b exits from between the internal teeth 77b on the connection ring 77 to deregulate the rotation of the internal gear 72 in the circumferential direction. The meshing teeth 66d on the first carrier 66 mesh with the meshing teeth 72d on the internal gear 72. The internal gear 72 unlocked in the circumferential direction and the first carrier 66 rotate together to transmit the same rotation as the external gear 66c to the external gear 76c. More specifically, the speed switch lever 79 is operated rearward to enable a high speed mode in which the second middle planetary gear mechanism 70 does not perform speed reduction.

A rib 78e is located at the lateral center on a bottom surface of the connector 78b. The rib 78e extends in the front-rear direction, and protrudes downward. This structure increases the rigidity of the connector 78b to prevent flexure, thus allowing the internal gear 72 to be positionally stable after operated with the speed switch ring 78. The rib 78e is received in a groove 51f on an upper surface of the motor bracket base 51a. The groove 51f extends in the front-rear direction and recedes downward. The slit 50g on the gear case 50 is located above the groove 51f.

The front planetary gear mechanism 80 includes an internal gear 82, multiple (six) planetary gears 84, and a carrier 86. The internal gear 82 is rotatable in the circumferential direction inside the gear housing 52. The planetary gears 84 include external teeth meshing with internal teeth on the internal gear 82. The carrier 86 supports the planetary gears 84 in a rotatable manner.

The internal gear 82 has, on its front surface, a cylindrical internal teeth portion 82a having multiple (six) cam projections 82b arranged at circumferentially predetermined intervals. The cam projections 82b protrude frontward. The internal teeth portion 82a has, on its outer surface, multiple (six) protrusions 82c. The protrusions 82c protrude radially outward. Each protrusion 82c is located circumferentially in the middle between the cam projections 82b on the internal teeth portion 82a.

The planetary gears 84 mesh with the external gear 76c of the second carrier 76.

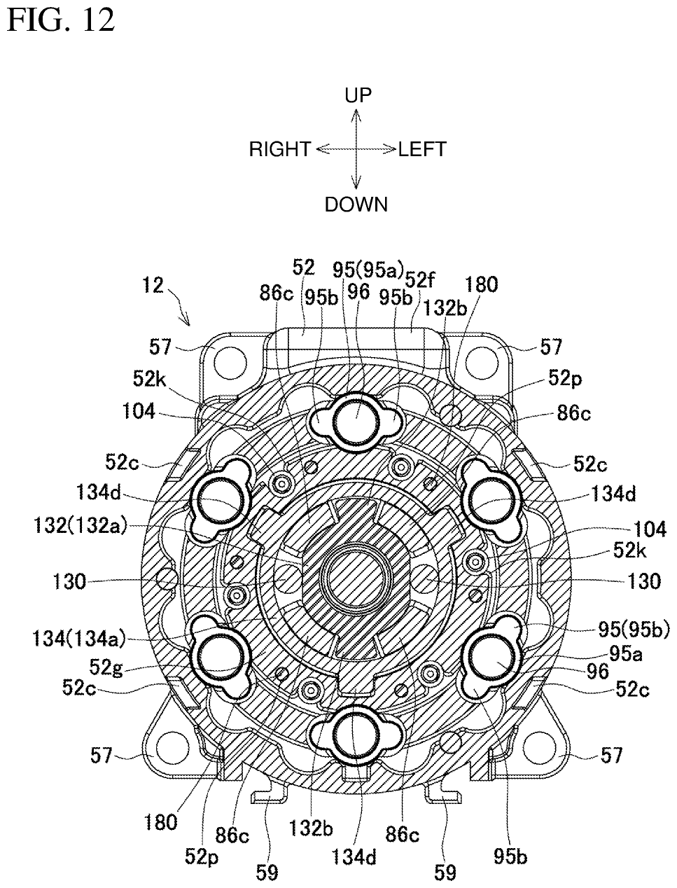

The carrier 86 includes multiple (six) pins 86b. The pins 86b protrude rearward from the rear surface of a disk member 86a having a center hole. Each pin 86b supports a single planetary gear 84. As shown in FIG. 12, the carrier 86 includes multiple (four) tab members 86c. The tab members 86c each are a quarter cylinder protruding frontward from the middle of the front surface of the disk member 86a. The multiple (four) tab members 86c are aligned circumferentially.

The change ring 54 is located radially outward from an inner cylinder 52g in the gear housing 52. The inner cylinder 52g has a smaller diameter than the outer cylinder 52a. The front end of the inner cylinder 52g is located more frontward than the front end of the outer cylinder 52a.

The change ring 54 includes a change ring base 54a and a rib 54b. The change ring base 54a is a cylinder tapered frontward, and includes recesses and protrusions on an outer surface. The rib 54b protrudes radially inward from the inner surface of the change ring base 54a in the middle in the front-rear direction.

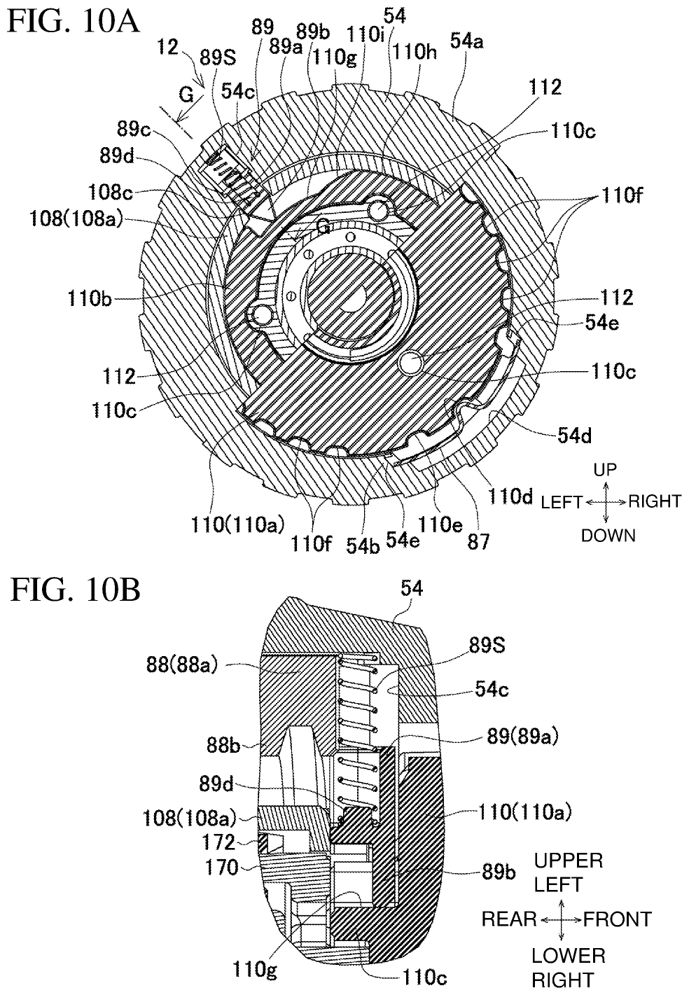

The change ring base 54a has a hole 54c (upper left in FIG. 10A) in the inner surface at the same position as the rib 54b in the front-rear direction. The hole 54c recedes radially more outward than the inner surface of the change ring base 54a. A recess 54d (lower right in FIG. 10A) faces the hole 54c. The recess 54d recedes radially more outward than other part of the inner surface of the change ring base 54a, and circumferentially extends in an arc. Engagement parts 54e are located on both circumferential ends of the recess 54d. The engagement parts 54e engage with a leaf spring 87. The leaf spring 87 has a middle portion swelling radially inward, and is urged radially inward.

A clutch switch ring 88 is located behind the rib 54b radially inside the change ring 54.

The clutch switch ring 88 includes a clutch switch ring base 88a, a thread 88b, a lock lever holder 88c, and a protruding piece 88d. The clutch switch ring base 88a is in ring shape. The thread 88b is helically formed on the inner surface of the clutch switch ring base 88a. The lock lever holder 88c extends radially outward from a portion of the clutch switch ring base 88a, and protrudes frontward while being bifurcated. The protruding piece 88d opposite to the lock lever holder 88c extends frontward and radially inward from a portion of the clutch switch ring base 88a.

The protruding piece 88d has the same shape as the recess 54d on the change ring 54 as viewed from the front. The recess 54d receives the protruding piece 88d to rotate the change ring 54 and the clutch switch ring 88 together. The lock lever holder 88c is received in a radially inward part of the hole 54c.

A lock lever 89 extends radially between the change ring 54 and the clutch switch ring 88.

The lock lever 89 as a locking member includes a lock lever base 89a, a follower 89b, and lock lever ribs 89c. The lock lever base 89a is a prism having open sides radially outward and rearward. The follower 89b is a triangular plate extending radially inward from a radially inner front end of the lock lever base 89a. The lock lever ribs 89c protrude outward in the circumferential direction from radially outer ends of the lock lever base 89a.

The lock lever base 89a is held by the lock lever holder 88c (between the bifurcated protrusions) of the clutch switch ring 88. The lock lever base 89a is received in the hole 54c. This causes the clutch switch ring 88 to rotate together with the lock lever 89.

The lock lever base 89a internally includes a spring 89S as an elastic member. The spring 89S extends radially. A radially outer end of the spring 89S comes in contact with the radially outer bottom of the hole 54c (inner surface of the change ring 54). A radially inner end of the spring 89S comes in contact with a radially inner surface of the lock lever base 89a, and urges the lock lever 89 radially inward. As shown in FIG. 10B, the lock lever base 89a includes a spring holding projection 89d on its radially inner surface. The spring holding projection 89d protrudes upward from other portion, and is received in an inner diameter portion of the spring 89S to hold the spring 89S.

The lock lever ribs 89c are not in contact with the hole 54c. In placing the lock lever 89 and the spring 89S, the lock lever ribs 89c can be placed in the hole 54c when aligned correctly. This prevents the lock lever 89 from being oriented incorrectly. Also, the lock lever ribs 89c are temporarily caught by the hole 54c, and thus prevent the lock lever 89 and the spring 89S from slipping out of the hole 54c.

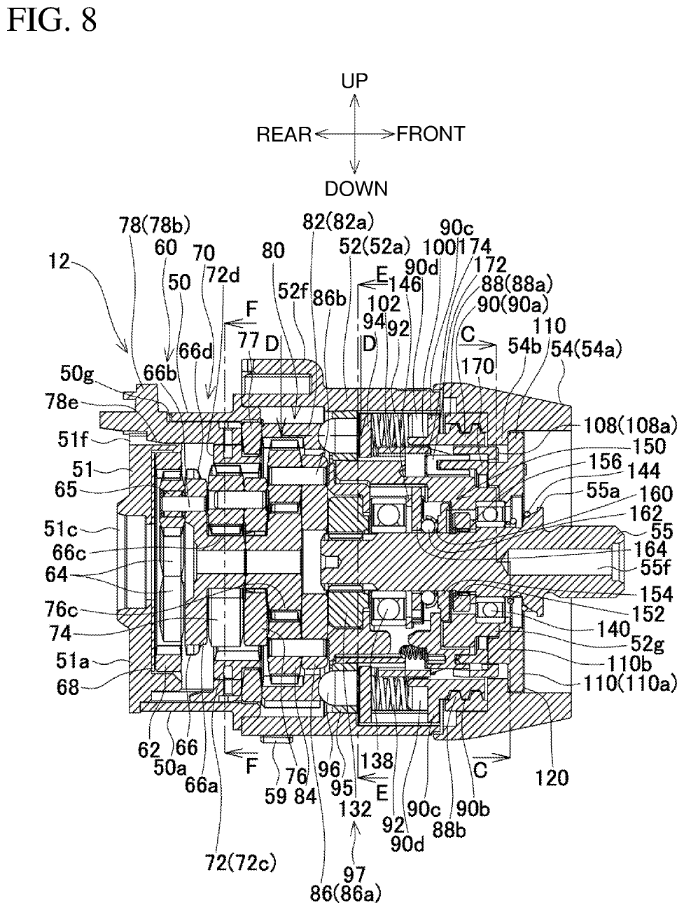

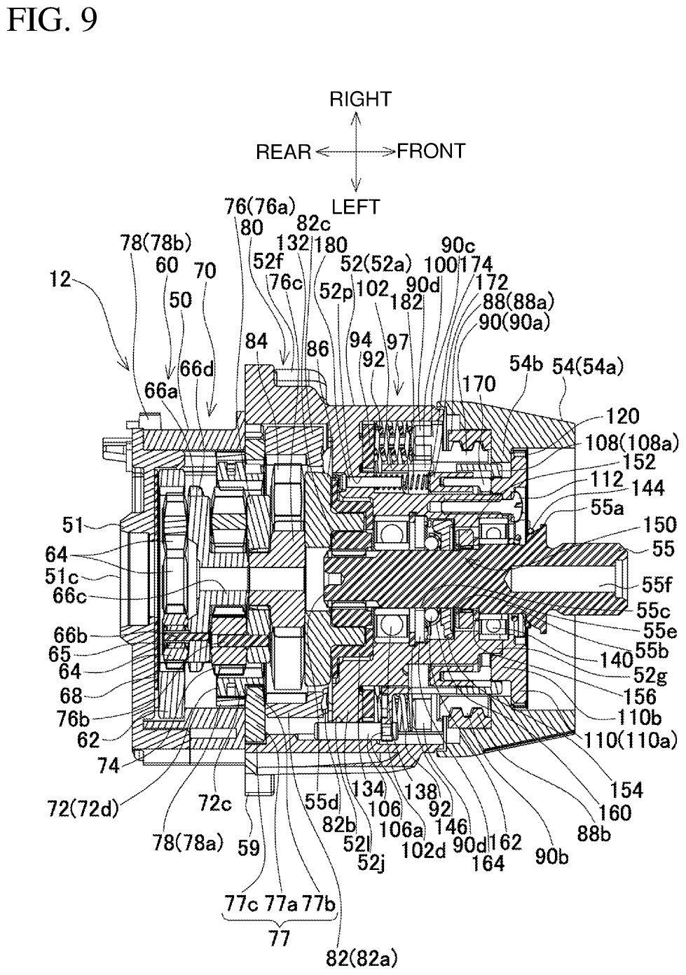

As shown in FIGS. 8 and 9, an annular spring holder 90 as an elastic holder is located radially inward from the clutch switch ring 88.

The spring holder 90 includes a cylindrical spring holder base 90a having a thread 90b on its outer surface. The thread 90b includes a thread to mesh with the thread 88b on the clutch switch ring 88. The clutch switch ring 88 rotates to move the spring holder 90 in the front-rear direction.

The spring holder base 90a includes, in its rear portion, three flanges 90c and spring holding members 90d. The flanges 90c, at multiple (12) positions, semi-circularly protrude radially outward with respect to the front portion. The protrusions are connected at their radially inward portions into sets of a predetermined number of (four) semi-circular protrusions.

The spring holding members 90d are columns protruding rearward from the semi-circular protrusions on the flanges 90c. The flanges 90c are separate from each other in the circumferential direction by troughs 90e that are recesses circumferentially inward from the outer contours of the flanges 90c.

Ribs 90f are formed between predetermined spring holding members 90d. The ribs 90f protrude rearward from the rear end of the spring holder base 90a. The ribs 90f protrude rearward to the same height as the spring holding members 90d. The ribs 90f regulate radially outward movement of the components arranged radially inward, and hold and prevent the components from slipping off.

The lower flange 90c includes a protruding piece 90g protruding radially outward between the lower semi-circular protrusions.

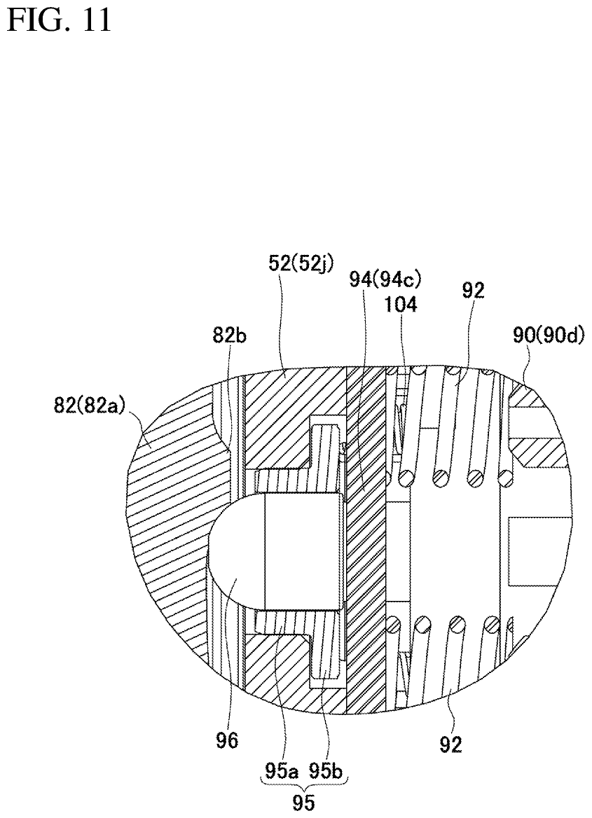

As shown in FIG. 11, each spring holding member 90d holds a clutch pin coil spring 92. The clutch pin coil spring 92 is an elastic member for a clutch pin and for urging the internal gear 82. A single washer 94 is located behind each clutch pin coil spring 92. The washer 94 has the same shape as the flanges 90c. The front end of each clutch pin coil spring 92 comes in contact with the rear surface of the flange 90c on the spring holder 90. The rear end of each clutch pin coil spring 92 comes in contact with the front surface of the washer 94.

The washer 94 includes multiple (12) protrusions 94b. The protrusions 94b are semicircles protruding radially outward from an annular washer base 94a. Six extensions 94c in total are each located between adjacent semi-circular protrusions on the washer 94 protruding radially outward. Each extension 94c is an arc extending radially inward from a radially inner edge of the washer base 94a. Similarly to the troughs 90e on the spring holder 90, the washer 94 has three troughs 94d in total.

As shown in FIGS. 8 and 9, the spring holder 90, the clutch pin coil springs 92, and the washer 94 are located between the inner cylinder 52g and the outer cylinder 52a in the gear housing 52. A front inner surface of the outer cylinder 52a has the same contour as the flange 90c or the washer 94. The flanges 90c and the protruding piece 90g lock the spring holder 90 in a nonrotatable manner. The protrusions 94b lock the washer 94 in a nonrotatable manner. In addition to the protrusions 94b, the washer 94 may include protruding pieces between, for example, the protrusions 94b to lock the washer 94 in a nonrotatable manner.

In the gear housing 52, an annular wall 52j extends vertically and laterally to connect the inner cylinder 52g to the outer cylinder 52a. The wall 52j has a front surface shaped in correspondence with the flanges 90c or the washer 94.

As shown in FIG. 11, the wall 52j has circular holes behind extensions 94c on the washer 94. Each hole receives a columnar clutch pin 96 from the front through a cylindrical clutch pin sleeve 95.

Each clutch pin sleeve 95 includes a cylindrical clutch pin sleeve base 95a and a pair of flanges 95b. The flanges 95b protrude radially outward from the outer surface of the front end of the clutch pin sleeve base 95a. For adjacent clutch pin sleeves 95, the flange 95b on the clutch pin sleeve 95 located forward in the circumferential direction faces the flange 95b on the clutch pin sleeve 95 located rearward in the circumferential direction. The flanges 95b increase the area supported by the gear housing 52. The clutch pin sleeves 95 and the clutch pins 96 can thus be shorter in the front-rear direction while maintaining the support strength.

Each clutch pin 96 is in column shape with a rounded rear end. The clutch pin 96 has its front portion received in the clutch pin sleeve base 95a and thus is integrally held by the clutch pin sleeve 95.

The front end of each clutch pin sleeve 95 and the front end of each clutch pin 96 are in contact with the rear surface of the washer 94.

The rear end of each clutch pin 96 may come in contact with the front surface of the cylindrical internal teeth portion 82a of the internal gear 82.

A clutch mechanism 97 includes the spring holder 90, the clutch pin coil springs 92, the washer 94, the clutch pin sleeves 95, and the clutch pins 96. The clutch mechanism 97 may include the cam projections 82b. At least the clutch pin sleeves 95 or the washer 94 may be eliminated.

As shown in FIGS. 8 and 9, a support ring 100 and a pin holder 102 are located radially inside the spring holder 90. The pin holder 102 is located behind the support ring 100.

The support ring 100 includes a support ring base 100a including multiple (three) cam projections 100b (pin holder cams) on the front end at circumferentially equal intervals. The support ring base 100a is in cylindrical shape having an axis extending in the front-rear direction. The cam projections 100b are trapezoidal and protrude more frontward than other portions. Multiple (three) protruding pieces 100c are each circumferentially located between the cam projections 100b. The protruding pieces 100c protrude rearward from the rear end of the support ring base 100a.

The pin holder 102 includes a pin holder base 102a including, in its front end, recesses 102b, multiple (six) spring holding members 102c, and multiple (three) pin holding members 102d. The pin holder base 102a is in cylindrical shape having an axis extending in the front-rear direction. The recesses 102b correspond to the protruding pieces 100c on the support ring 100. The spring holding members 102c protrude radially inward and rearward from the inner surface of the pin holder base 102a. The multiple (six) spring holding members 102c are located at circumferentially equal intervals. The pin holding members 102d protrude radially outward from the outer surface of the pin holder base 102a. The multiple (three) pin holding members 102d are located at circumferentially equal intervals. The recesses 102b are circumferentially displaced from the pin holding members 102d.

Each spring holding member 102c includes a rearward protrusion to receive the front end of a pin holder coil spring 104 as an elastic member. The rear portions of the pin holder coil springs 104 are received in recesses 52k shown in FIG. 12. The recesses 52k are columnar and recede rearward from the front surface of the wall 52j of the gear housing 52. The six recesses 52k in total are located in correspondence with the spring holding members 102c. The pin holder coil springs 104 urge the pin holder 102 forward.

As shown in FIG. 9, each pin holding member 102d holds the front end of an internal gear lock pin 106. The internal gear lock pins 106 are in columnar shape extending in the front-rear direction. Each internal gear lock pin 106 has an annular groove 106a on its front end. Each groove 106a receives a bifurcated distal end of the pin holding member 102d. Each pin holding member 102d and each internal gear lock pin 106 extend between corresponding clutch pin coil springs 92 and through the outside of the troughs 90e and 94d on the spring holder 90 and the washer 94. Each internal gear lock pin 106 passes through a corresponding pin hole 521 in the wall 52j of the gear housing 52. The rear end of each internal gear lock pin 106 is movable forward and rearward relative to a radially outward surface of the third internal gear 82.

A drill switch ring 108 is located in front of the support ring 100 and radially inside the change ring 54 and the spring holder 90. The drill switch ring 108 is annular and is formed from a resin.

As shown in FIGS. 8 to 10B, the drill switch ring 108 includes a cylindrical drill switch ring base 108a and three cam recesses 108b. At the rear of the drill switch ring base 108a, the cam recesses 108b are trapezoidal and recede frontward in correspondence with the cam projections 100b on the support ring 100. The support ring 100 is located behind the cam recesses 108b.

The drill switch ring 108 includes a lock lever receiving recess 108c (locking member receiving recess). The lock lever receiving recess 108c recedes rearward from the front of the drill switch ring base 108a to have the same width (circumferential dimension) as the lock lever base 89a. The lock lever receiving recess 108c allows the lock lever 89 to pass through.

The drill switch ring 108 has multiple (three) engagement projections 108d. The engagement projections 108d protrude radially inward from the inner surface of the drill switch ring base 108a.

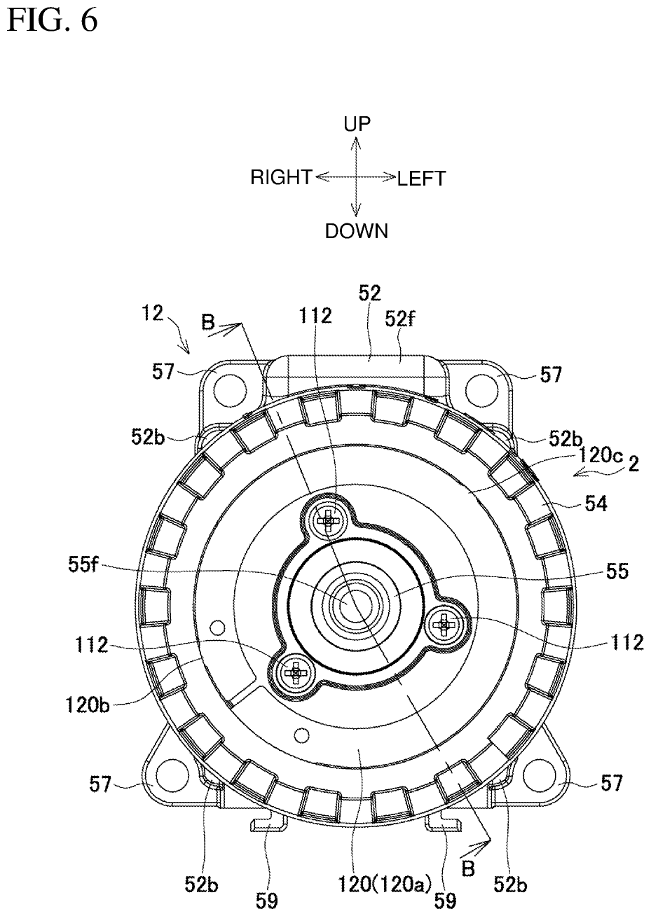

The change ring 54 is located radially outward from the inner cylinder 52g in the gear housing 52 and is attached in an axially rotatable manner. As shown in FIG. 6, the front end of the inner cylinder 52g receives an annular cam plate 110 fastened with multiple (three) screws 112. The cam plate 110 is located in front of the rib 54b on the change ring 54. The change ring 54 is placed between the cam plate 110 and a front end opening of the outer cylinder 52a in the gear housing 52.

As shown in FIGS. 8 to 10B, the cam plate 110 includes a front cam plate 110a, a rear cam plate 110b, and screw holes 110c. The front cam plate 110a is a disk with an opening. The rear cam plate 110b is a disk with an opening behind the front cam plate 110a, and has a smaller diameter than the front cam plate 110a. The screw holes 110c extend through the front cam plate 110a and the rear cam plate 110b to receive the screws 112.

The front cam plate 110a has a notch 110d, a notch 110e, and notches 110f on its circumference. The notches 110d and 110e, and the notches 110f recede radially inward from the circumference. The middle portion of the leaf spring 87 is received in any one of the notches 110d to 110f.

The circumference of the rear cam plate 110b defines the shape of a cam including a smaller diameter portion 110g, a larger diameter portion 110h, and a slope 110i. The slope 110i connects the smaller diameter portion 110g to the larger diameter portion 110h. The follower 89b in the lock lever 89 is in contact with and can follow the circumference of the rear cam plate 110b.

The rear cam plate 110b includes the smaller diameter portion 110g (upper left in FIG. 10A) opposite to the notches 110d and 110e on the front cam plate 110a across the center. More specifically, the notch 110e is located opposite to an end of the smaller diameter portion 110g adjacent to the slope 110i. The notches 110f are located in an area from a position opposite to an end of the larger diameter portion 110h adjacent to the slope 110i (bottom in FIG. 10A) to a position opposite to the other end of the larger diameter portion 110h adjacent to the smaller diameter portion 110g (right in FIG. 10A).

The front end of the inner cylinder 52g has multiple screw holes 52m. The screw holes 52m are located in correspondence with the screw holes 110c to receive the screws 112.

As shown in FIG. 10B, the central axis of the spring 89S is located rearward from the central axis of the lock lever 89. This prevents the urging force of the spring 89S from being applied away from the cam plate 110, and thus allows the lock lever 89 to operate in a reliable manner following the circumferential cam shape of the rear cam plate 110b.

A cover ring 120 formed from a thin metal plate is located in front of the circumference of the cam plate 110.

The cover ring 120 includes an annular cover ring base 120a, a tab piece 120b, and an engagement piece 120c. The tab piece 120b protrudes radially outward from a circumferential portion of the cover ring base 120a. The engagement piece 120c protrudes radially outward at a position opposite to the tab piece 120b. The cover ring 120 is locked in a nonrotatable manner with respect to the change ring 54 by the tab piece 120b and the engagement piece 120c. The cover ring 120 covers the circumference of the cam plate 110.

The tab piece 120b is shaped to correspond to the recess 54d on the change ring 54, and has a slit. The recess 54d receives the tab piece 120b.

As shown in FIG. 12, spaces face each other between the tab members 86c on the third carrier 86. Rollers 130 are located in two facing spaces (right and left spaces in the figure).

Lock cams 132 are located in other two facing spaces (upper and lower spaces in the figure). Each lock cam 132 includes a cylinder 132a and a pair of protruding pieces 132b. The protruding pieces 132b protrude radially outward from the top and the bottom of the cylinder 132a. Each protruding piece 132b is located between the tab members 86c. A center hole of the cylinder 132a in the lock cam 132 is connected to the rear step 55d in the spindle 55 using a spline. This integrates the lock cam 132 and the spindle 55. The lock cam 132 rotates together with the third carrier 86 with each tab member 86c.

A cylindrical lock ring 134 is mounted on the front of the lock cam 132. The lock ring 134 is fixed inside the inner cylinder 52g in the gear housing 52. The lock ring 134 includes a cylindrical lock ring base 134a, an inner flange 134b, an outer flange 134c, and multiple (three) protrusions 134d. The inner flange 134b protrudes inward from the inner surface of the front end of the lock ring base 134a. The outer flange 134c protrudes outward from the outer surface of the rear end of the lock ring base 134a. The protrusions 134d protrude radially outward and frontward from the side surface of the lock ring base 134a. The multiple (three) protrusions 134d are located at circumferentially equal intervals. The rollers 130, the lock cam 132, and the tab members 86c on the third carrier 86 are located behind the inner flange 134b. The protrusions 134d are received on the inner surface of the inner cylinder 52g in the gear housing 52 with the corresponding shape to fasten the lock ring 134 in a nonrotatable manner.

As shown in FIGS. 8 and 9, a spindle rear bearing 138 and a spindle front bearing 140 hold the spindle 55 in a manner movable in the front-rear direction and axially rotatable. The spindle rear bearing 138 is located in front of the lock ring 134. The spindle front bearing 140 is located radially outside the front step 55b.

The spindle front bearing 140 is located outside the front step 55b in the spindle 55.

A spindle coil spring 144, which is an elastic member, is located between the spindle front bearing 140 and the spindle flange 55a. The rear surface of the spindle flange 55a and the spindle coil spring 144 are flared to have a slope shape having a gradually wider diameter toward the front.

A clip 146 presses the front surface of the outer ring of the spindle rear bearing 138. The clip 146 is received in a groove on the inner surface of the inner cylinder 52g in the gear housing 52.

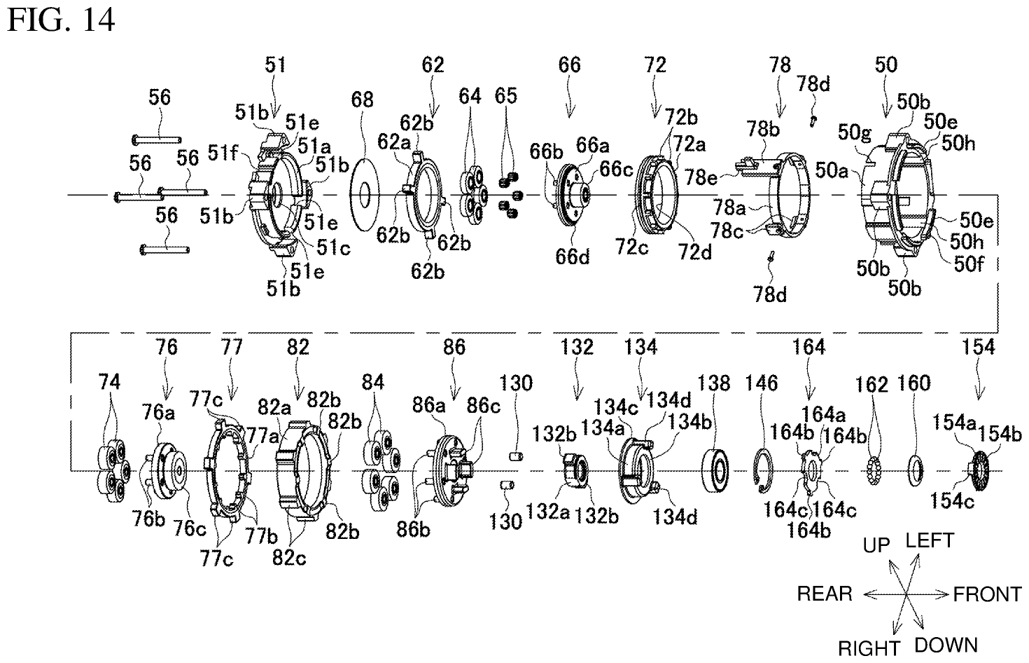

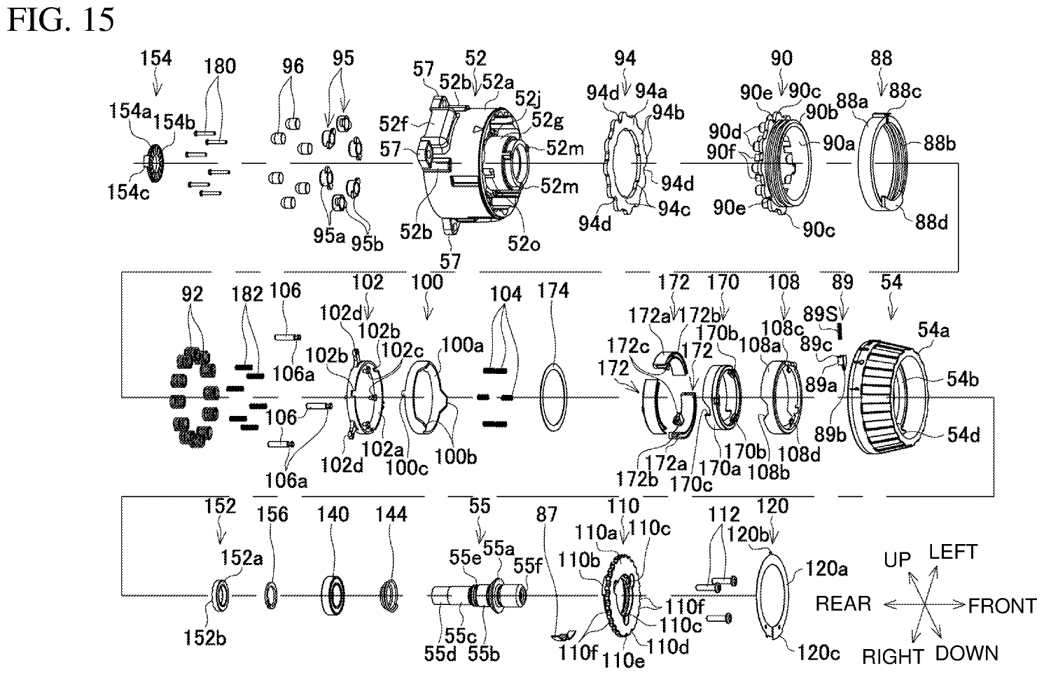

A vibration mechanism 150 is located between the spindle front bearing 140 and the clip 146. The vibration mechanism 150 includes a first vibration cam 152 and a second vibration cam 154. The first vibration cam 152 and the second vibration cam 154 are annular and held by the middle step 55c in the spindle 55. To indicate the continuity of FIGS. 14 and 15, the two figures redundantly show the second vibration cam 154. The vibration driver drill 1 actually includes a single second vibration cam 154.

The first vibration cam 152 includes a cylindrical first vibration cam base 152a having a first cam surface 152b on its rear surface. The first cam surface 152b has multiple cam teeth. The first vibration cam 152 is integrally fixed to the spindle 55 with a circlip 156. The circlip 156 is fixed to the outer surface of the front end of the middle step 55c in the spindle 55. The spindle 55 in a normal state is urged by the spindle coil spring 144 frontward until the circlip 156 comes in contact with the inner ring of the spindle front bearing 140.

The second vibration cam 154 includes an annular second vibration cam base 154a having a second cam surface 154b on its front surface. The second cam surface 154b has multiple cam teeth. The second vibration cam base 154a includes multiple (three) tabs 154c on the rear surface at circumferentially equal intervals. The tabs 154c protrude rearward. The second vibration cam 154 is received on the spindle 55 in a circumferentially movable manner.

A ball holding washer 160, multiple steel balls 162, and a ball receiving washer 164 are located between the second vibration cam 154 and the clip 146.

As shown in FIGS. 8 and 9, the ball holding washer 160 is adjacent to the rear surface of the second vibration cam base 154a. The ball holding washer 160 is a bowl-shaped member having an inner circumference at its front end and an outer circumference at its rear end. The ball holding washer 160 holds and circumferentially aligns the balls 162 on its curved rear surface.

The ball receiving washer 164 includes an annular ball receiving washer base 164a, multiple (three) protruding portions 164b, and narrowed portions 164c. The protruding portions 164b protrude radially outward from the washer base 164a. The multiple (three) protruding portions 164b are located at circumferentially equal intervals. The narrowed portions 164c are each circumferentially located between the protruding portions 164b. The protruding portions 164b are received in recesses on the inner surface of the inner cylinder 52g in the gear housing 52 to lock the ball receiving washer 164 in a nonrotatable manner.

The vibration mechanism 150 may include at least the circlip 156, the ball holding washer 160, the balls 162, or the ball receiving washer 164.

As shown in FIGS. 8 and 9, a vibration switch ring 170, which is formed from a metal (sintered metal), is located radially inward from the drill switch ring 108. A set of (three) vibration switch levers 172 (vibration switch members, part of vibration switch means) is located behind the vibration switch ring 170. Each vibration switch lever 172 is an arc of one third of the entire circumference. A washer 174 is located behind the vibration switch levers 172.

The vibration switch ring 170 includes a cylindrical vibration switch ring base 170a, multiple (three) engagement recesses 170b, and multiple (three) cam recesses 170c. The engagement recesses 170b recede radially inward from the front end of the vibration switch ring base 170a. The multiple (three) engagement recesses 170b are located at circumferentially equal intervals. The cam recesses 170c recede frontward from the rear end of the vibration switch ring base 170a. The cam recesses 170c are located at the circumferentially same positions as the engagement recesses 170b. The engagement recesses 170b receive and engage with the engagement projections 108d. The engagement projections 108d are located in correspondence with the drill switch ring 108. The vibration switch ring 170 rotates integrally with the drill switch ring 108.

The vibration switch levers 172 are formed from a metal (injection metal). Each vibration switch lever 172 includes a vibration switch lever base 172a, a raised portion 172b (vibration switch cam), and a vibration switch tab 172c. The vibration switch lever base 172a is open frontward, and has a U-shaped cross section. The raised portion 172b on the vibration switch lever base 172a is raised frontward in correspondence with the cam recess 170c. The vibration switch tab 172c protrudes radially inward and rearward from the middle of the radially internal surface of each vibration switch lever base 172a. The vibration switch levers 172 are located radially outside the inner cylinder 52g to have the vibration switch tabs 172c received in multiple (three) radial holes 52o (through-holes). The holes 52o are open at circumferentially equal intervals in the middle of the inner cylinder 52g in the gear housing 52 in the front-rear direction. The vibration switch levers 172 are located inside the support ring 100.

The vibration switch tabs 172c are located radially outside the narrowed portions 164c of the ball receiving washer 164. More specifically, the ball receiving washer 164 includes the narrowed portions 164c to avoid contact with the vibration switch tabs 172c.

The vibration switch tabs 172c are movable forward and rearward between the tabs 154c protruding rearward at the rear of the second vibration cam base 154a.

As shown in FIGS. 9 and 12, pin holes 52p extend in the front-rear direction in portions between the three holes 52o in the inner cylinder 52g in the gear housing 52 and circumferentially adjacent to the six recesses 52k receiving the pin holder coil springs 104. Each pin hole 52p receives a pin 180 from the rear. Each pin hole 52p has an enlarged front portion larger than its rear portion. A vibration switch lever coil spring 182, which is an elastic member, is located between the enlarged portion and a front portion of each pin 180. The front ends of the vibration switch lever coil springs 182 come in contact with the washer 174 behind the vibration switch levers 172. The vibration switch lever coil springs 182 urge the washer 174 and the vibration switch levers 172 forward.

More specifically, three or more (six) vibration switch lever coil springs 182 as urging members are aligned circumferentially. A single vibration switch lever 172 comes in contact with multiple (two) vibration switch lever coil springs 182 for urging (pressing) the vibration switch lever 172.

The rear ends of the pins 180 are located in front of the outer flange 134c on the lock ring 134.

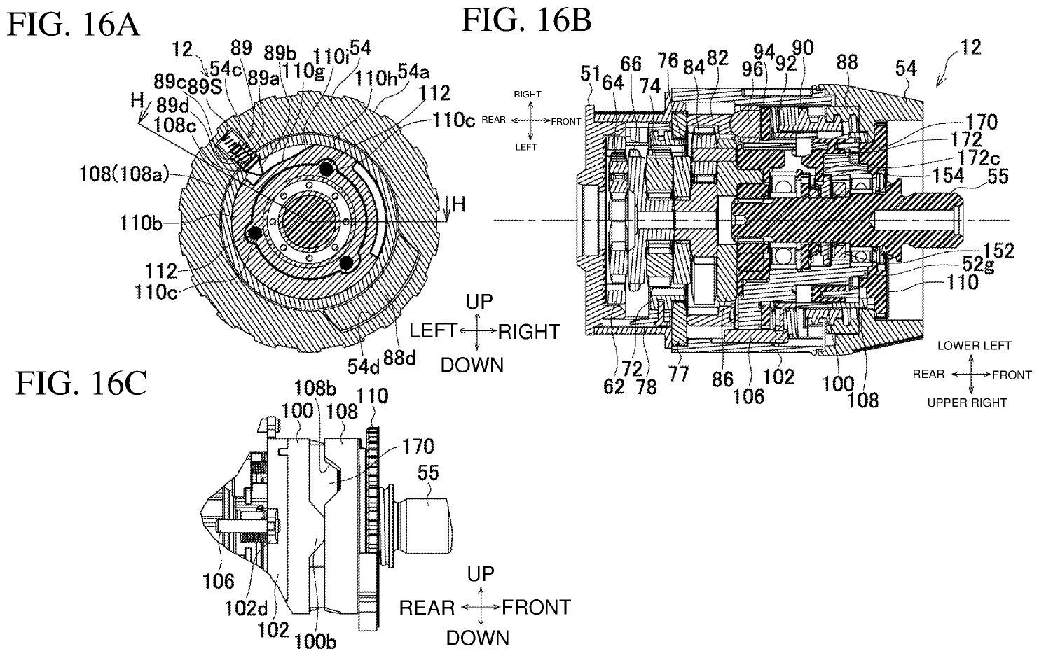

As shown in FIGS. 16A to 16C, at the rotational position of the change ring 54 (as in FIG. 10A), the leaf spring 87 has the middle portion received in the notch 110d. In this state, the rear end of the drill switch ring 108 excluding the cam recesses 108b comes in contact with the front ends of the cam projections 100b on the support ring 100 to move the support ring 100 rearward. The pin holder 102 then moves rearward, and the internal gear lock pins 106 enter between the circumferential protrusions 82c on the radially outward surface of the third internal gear 82. The internal gear lock pins 106 come in contact with the side surfaces of the protrusions 82c to prevent the third internal gear 82 from rotating. This locks the internal gear 82 (clutch nonoperational state) although the clutch pins 96 press the internal gear 82.

At the rotational position, the vibration switch levers 172 have the raised portions 172b received in the corresponding cam recesses 170c on the vibration switch ring 170 to move forward. The vibration switch tabs 172c move forward and enter between the tabs 154c on the second vibration cam 154. In this state, the vibration switch tabs 172c are caught by the tabs 154c to prevent the second vibration cam 154 from rotating. Thus, the vibration switch levers 172 prevent the second vibration cam 154 from rotating with the vibration switch tabs 172c. When the spindle 55 rotates, the first vibration cam 152 rotates integrally with the spindle 55, whereas the second vibration cam 154 does not rotate. When the spindle 55 moves rearward, the first cam surface 152b rotates in contact with the locked second cam surface 154b, causing the spindle 55 to vibrate axially (vibration mechanism operational state). The vibration driver drill 1 includes the vibration switch unit including the vibration switch ring 170, the vibration switch levers 172, the pins 180, and the vibration switch lever coil springs 182.

At this rotational position, the electric vibration driver drill 1 enters a vibration drill mode in which the clutch does not operate and no vibration is generated.

When the vibration switch levers 172 are moved forward, the rear end of the vibration switch ring base 170a relatively enters the vibration switch lever bases 172a, increasing the degree of contact between the vibration switch levers 172, and between the vibration switch ring 170 and the vibration switch levers 172. This achieves tight contact between components frontward from the vibration switch levers 172 (inside the inner cylinder 52g in the gear housing 52), and prevents dust and leakage of grease used inside the components.

The vibration switch lever coil springs 182 urge the vibration switch levers 172 forward to allow the raised portions 172b to smoothly enter the cam recesses 170c.

At this rotational position, the follower 89b in the lock lever 89 is received in the smaller diameter portion 110g of the rear cam plate 110b, and the lock lever base 89a is received in the lock lever receiving recess 108c on the drill switch ring 108. Thus, the change ring 54 can integrally rotate with the drill switch ring 108.

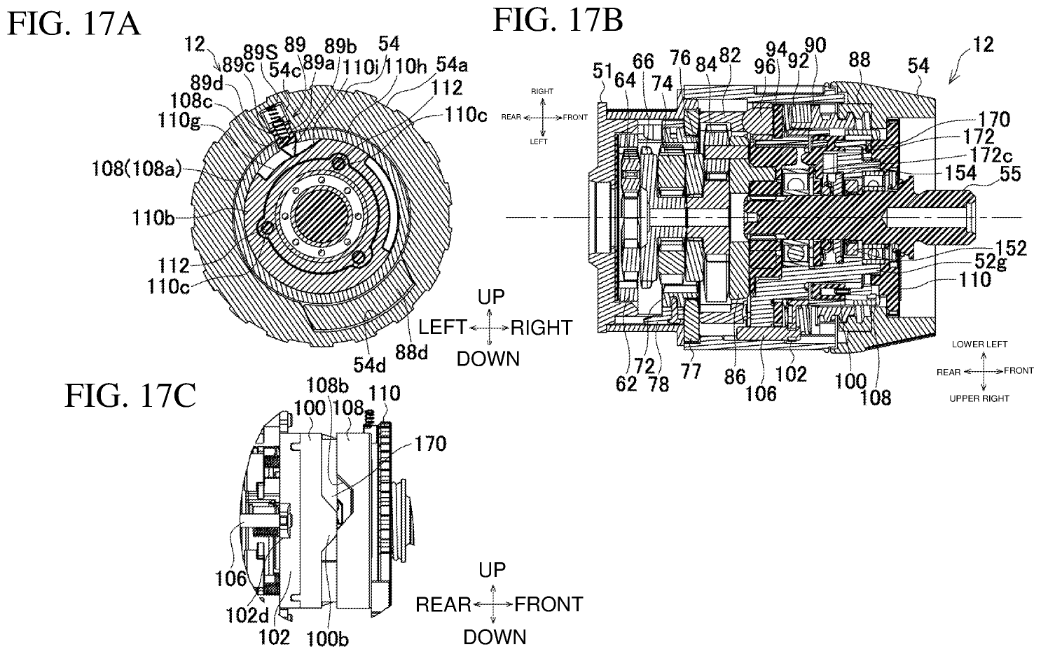

When the change ring 54 is rotated from the above rotational position until the middle portion of the leaf spring 87 is received in the notch 110e, the follower 89b reaches an end of the smaller diameter portion 110g adjacent to the slope 110i as shown in FIGS. 17A to 17C.

At this rotational position, the rear end of the drill switch ring 108 excluding the cam recesses 108b comes in contact with the front ends of cam projections 100b on the support ring 100. The support ring 100, the pin holder 102, and the internal gear lock pins 106 remain rearward, locking the internal gear 82 (clutch nonoperational state).

At this rotational position, the raised portions 172b on the vibration switch levers 172 exit from the cam recesses 170c on the vibration switch ring base 170a, and the front ends of the raised portions 172b come in contact with the vibration switch ring base 170a excluding the cam recesses 170c. The vibration switch levers 172 are moved rearward against the urging force from the vibration switch lever coil springs 182. This moves the vibration switch tabs 172c rearward from between the tabs 154c on the second vibration cam 154, allowing rotation of the second vibration cam 154. When the spindle 55 rotates, the first vibration cam 152 rotates integrally with the spindle 55 to rotate the second vibration cam 154 with the first cam surface 152b and the second cam surface 154b. However, the second vibration cam 154 is received on the spindle 55 in a rotatable manner to generate no vibration (vibration mechanism nonoperational state).

More specifically, at this rotational position, the vibration driver drill 1 enters a drill mode in which the clutch does not operate and no vibration is generated.

When the change ring 54 is rotated from the above rotational position until the middle portion of the leaf spring 87 is received in the notch 110f (closest to the notch 110e and circumferentially opposite to the notch 110d across the notch 110e), the follower 89b climbs the slope 110i to move from the smaller diameter portion 110g to the larger diameter portion 110h. Before the follower 89b reaches the larger diameter portion 110h, the lock lever base 89a exits radially outwardly from the lock lever receiving recess 108c on the drill switch ring 108.

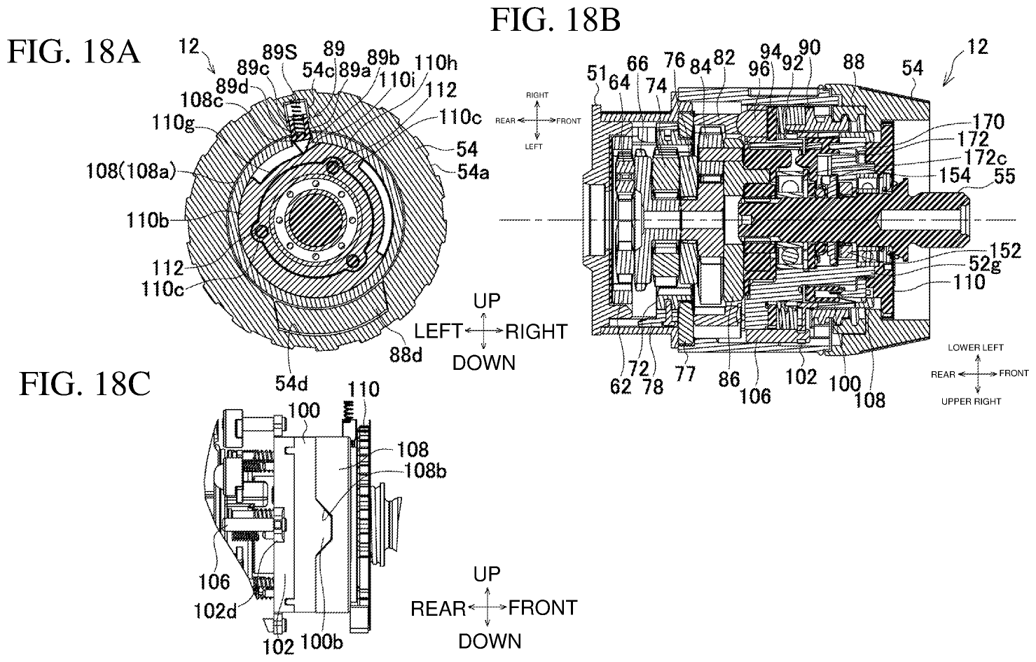

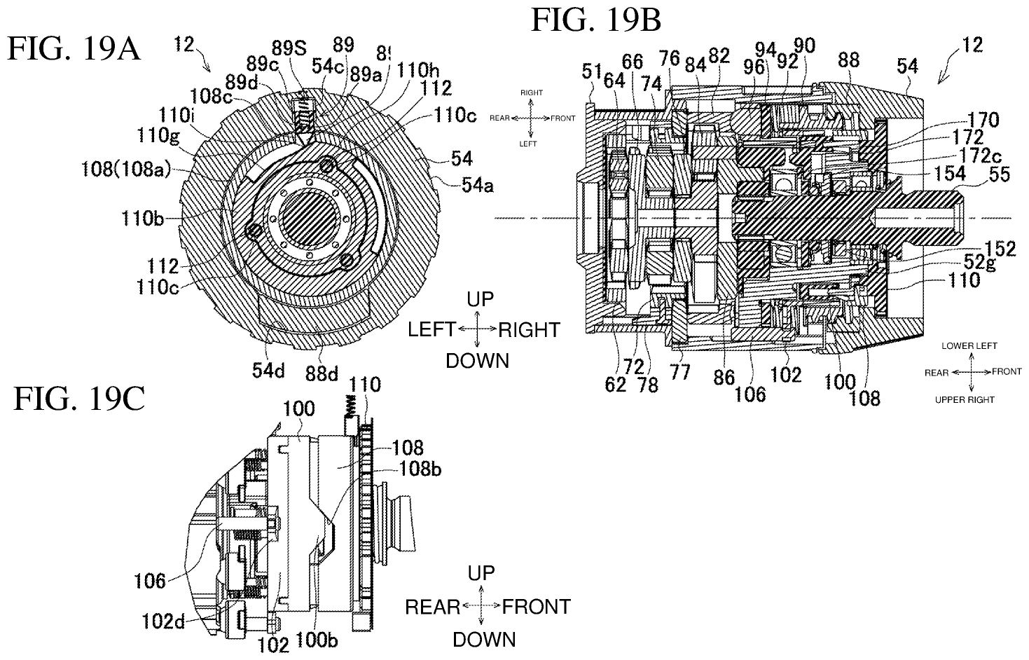

FIGS. 18A to 18C show the follower 89b climbing the slope 110i. FIGS. 19A to 19C show the follower 89b at a higher (more radially outward) position on the slope 110i than in FIGS. 18A to 18C and the lock lever base 89a immediately before exiting from the lock lever receiving recess 108c.

As shown in FIGS. 18A to 18C, the slope 110i causes the lock lever 89 to disengage from the drill switch ring 108. The cam recesses 108b on the drill switch ring 108 receive the cam projections 100b on the support ring 100 (refer to FIG. 18C). This moves the support ring 100 and the pin holder 102 forward, causing the internal gear lock pins 106 to retract forward from between the protrusions 82c on the third internal gear 82.

As shown in FIGS. 19A to 19C, the cam recess 108b on the drill switch ring 108 is passing the cam projection 100b on the support ring 100 (refer to FIG. 19C) immediately before the lock lever base 89a exits from the lock lever receiving recess 108c.

When the follower 89b moves from the smaller diameter portion 110g to the larger diameter portion 110h, the lock lever base 89a of the lock lever 89 exits from the lock lever receiving recess 108c on the drill switch ring 108, causing the drill switch ring 108 not to rotate integrally with the change ring 54.

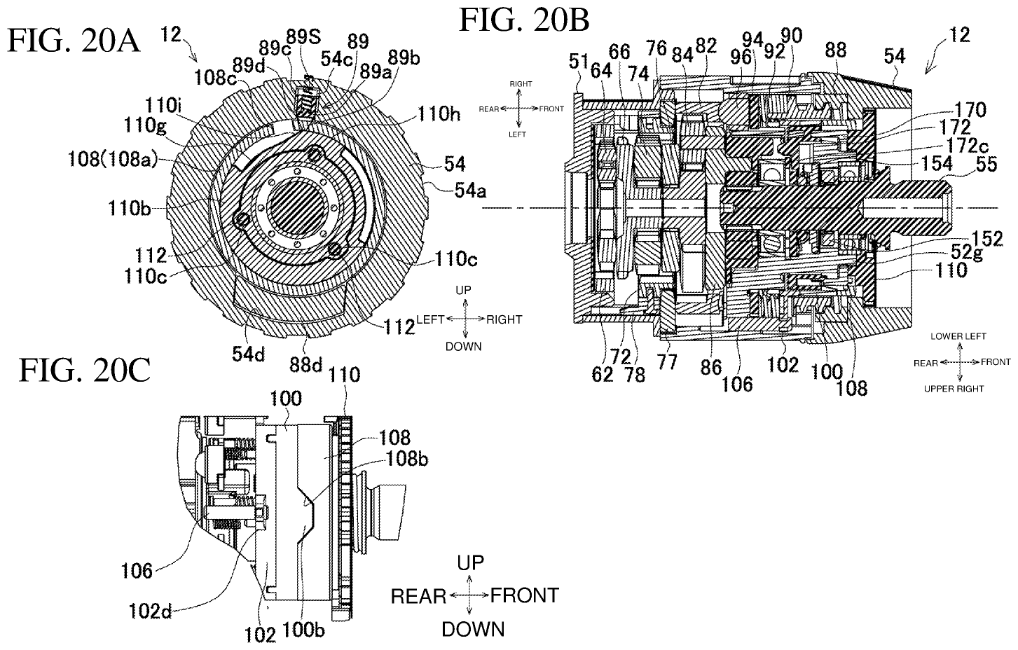

When the lock lever base 89a exits from the lock lever receiving recess 108c, the drill switch ring 108 returns to a rotational position at which the cam recesses 108b receive the cam projections 100b on the support ring 100 (refer to FIG. 20C) under the urging force from the pin holder coil springs 104 applied to the support ring 100 through the pin holder 102. This moves the support ring 100 and the pin holder 102 forward, and causes the internal gear lock pins 106 to retract from the radially outward surface of the third internal gear 82. Thus, the internal gear lock pins 106 no longer prevent the third internal gear 82 from rotating.

The pin holder coil springs 104 urge the support ring 100 through the pin holder 102 to allow the cam projections 100b to smoothly enter the cam recesses 108b. The urging force of the pin holder coil springs 104 retains the drill switch ring 108 at this rotational position until the change ring 54 is reverse-rotated to cause the lock lever 89 to re-enter the lock lever receiving recess 108c and receive a reverse rotational force. The above reverse rotation causes the cam projections 100b to exit from the cam recesses 108b against the urging force of the pin holder coil springs 104, moving the pin holder 102 rearward.

As shown in FIGS. 20A to 20C, when the change ring 54 is rotated until the middle portion of the leaf spring 87 is received in the notch 110f described above, the third internal gear 82 is no longer prevented from rotating by the internal gear lock pins 106, and is either regulated not to rotate or allowed to rotate by the clutch pins 96.

More specifically, each clutch pin 96 comes in contact with any of the cam projections 82b on the third internal gear 82, and regulates or allows rotation of the internal gear 82 in accordance with the elastic force of the clutch pin coil springs 92.

The clutch pins 96 press the front surface of the internal gear 82 in accordance with the elastic force of the clutch pin coil springs 92. At a torque less than a predetermined torque in accordance with the elastic force, the clutch pins 96 catch the cam projections 82b to lock the internal gear 82. Each cam projection 82b has a side surface including a rounded narrowed portion in correspondence with the rear end of the clutch pin 96. The clutch pins 96 in contact with the narrowed portions sufficiently resist a rotational force from the third internal gear 82. At the predetermined torque or more, the cam projections 82b move the clutch pins 96 forward against the elastic force and move over the clutch pins 96. The narrowed portions facilitate this movement over the clutch pins 96. The clutch pins 96 are passed over to allow rotation of the internal gear 82. Unless its rotation is prevented by other components, the internal gear 82 rotates and causes the carrier 86 (tab members 86c) to rotate without engagement, thus operating the clutch.

The vibration switch ring 170 is, together with the drill switch ring 108, retained at a rotational position corresponding to where the lock lever receiving recess 108c is located radially outward from the slope 110i. The vibration switch levers 172 are then moved rearward to retain the vibration switch ring 170 at a rotational position with no vibration generated.

More specifically, the vibration driver drill 1 at this rotational position becomes a clutch mode in which the clutch operates and no vibration is generated.

At this rotational position, the spring holder 90 is located rearmost to allow the clutch to operate through the engagement between the thread 90b and the thread 88b on the clutch switch ring 88 rotatable integrally with the change ring 54. In this state, the clutch pin coil springs 92, which urge the clutch pins 96 through the washer 94, are compressed most tightly to produce the largest urging force. Thus, the clutch operation torque (clutch setting torque) becomes the largest (clutch mode with a maximum clutch setting).

The vibration driver drill 1 includes multiple (twelve) clutch pin coil springs 92, rather than a single large clutch pin coil spring. This structure increases the spring constant and reduces the solid length compared with the structure using a single large coil spring. This structure is thus shorter in the front-rear direction. This structure may further include additional components between the clutch pin coil springs 92 without interrupting the operation of the clutch pin coil springs 92. The vibration driver drill 1 can thus be compact.

When the change ring 54 is rotated from the above rotational position until the middle portion of the leaf spring 87 is received in the next notch 110f, the follower 89b follows along the larger diameter portion 110h, and the lock lever base 89a passes radially outside the drill switch ring base 108a.

At this rotational position, the spring holder 90 moves forward, and the clutch pin coil springs 92 are expanded to reduce the urging force. This reduces the clutch setting torque (clutch mode with the second highest clutch setting).

When the change ring 54 is rotated further in the same direction until the middle portion of the leaf spring 87 is received in the farthest notch 110f (adjacent to the notch 110d), the spring holder 90 is located foremost to allow the clutch to operate. In this state, the clutch pin coil springs 92 are expanded most largely to urge the clutch pins 96 with the least urging force through the washer 94, causing the clutch setting torque to be the smallest (clutch mode with the minimum clutch setting).

As described above, changing the rotational position of the clutch switch ring 88 with the change ring 54 changes the position of the spring holder 90 in the front-rear direction. In this state, the distance between the flanges 90c and the washer 94 is changed to adjust the elastic force of the clutch pin coil springs 92. The washer 94 presses the clutch pins 96 through the clutch pin sleeves 95 in accordance with the elastic force of the clutch pin coil springs 92, and thus retains the third internal gear 82 with a torque corresponding to the elastic force.

When the change ring 54 rotates in the direction opposite to the above rotation direction, the above operation is reversed to cause the corresponding mode switching.

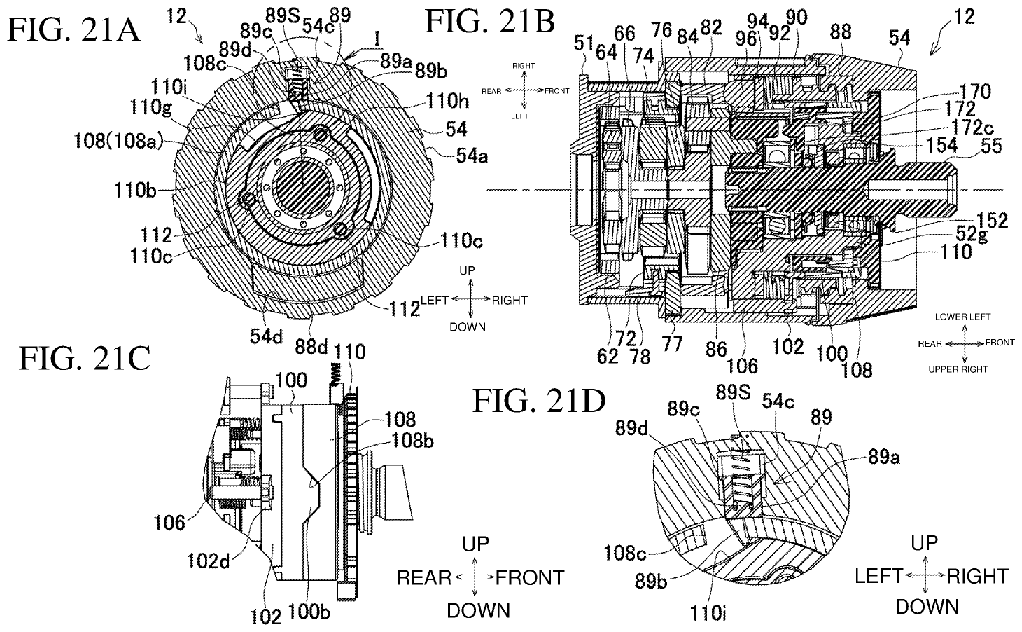

More specifically, in an intermediate state between the clutch mode (with the maximum clutch setting) and the drill mode (with the change ring 54 at the same rotational position as in FIGS. 19A to 19C), as shown in FIGS. 21A to 21D, the follower 89b may be out of contact from the slope 110i due to the shape of the slope 110i. This structure prevents unsuccessful rotation of the change ring 54 caused by the lock lever 89 incompletely caught by the lock lever receiving recess 108c (refer to FIG. 21D).

An example operation of the vibration driver drill 1 according to the present embodiment will now be described.

An operator holds the grip 6 and pulls the switch lever 8 to turn on the switch body 9 and powers the motor 10 from the battery 32, rotating the rotor 36 (motor shaft 37).

The motor shaft 37 rotates to rotate the fan 42. Air released through the air outlets 22a flows (blows) through the air inlets 20c to cool the mechanism including the motor 10 inside the housing 2.

The rotational force on the motor shaft 37 is reduced by the gear assembly 12 including the three-stage reduction mechanism, before transmitted to the spindle 55 and to a bit such as a drill or a screwdriver attached to the chuck 14.

The middle planetary gear mechanism 70 in the gear assembly 12 operates either in the high speed mode or the low speed mode in accordance with the position of the speed switch lever 79.

The mode can be selected from three operational modes and the clutch setting torque in the clutch mode can be selected in accordance with the rotational position of the change ring 54.

More specifically, the vibration mode is selected when the change ring 54 is at a rotational position corresponding to the notch 110d. In the vibration mode, the vibration switch levers 172 lock the second vibration cam 154 in a nonrotatable manner, and the rotating spindle 55 moves rearward to cause the first cam surface 152b to rub against the second cam surface 154b, thus axially vibrating the spindle 55.

The drill mode is selected when the change ring 54 is at a rotational position corresponding to the notch 110e. In the drill mode, the internal gear 82 in the front planetary gear mechanism 80 is locked and the second vibration cam 154 is allowed to rotate, without operating the clutch and generating vibrations. In the drill mode, the spindle 55 rotates, without the clutch being disengaged. The spindle 55 continues rotating independently of a load on the spindle 55 for drilling using a drill bit attached by the operator.

The clutch mode is selected when the change ring 54A is at a rotational position corresponding to the notch 110f. In the clutch mode, the front planetary gear mechanism 80 rotates without engagement, and disengages the clutch (stops transmitting torque) when a torque corresponding to the rotational position of the change ring 54 is applied to the spindle 55. A screw is fastened with a screwdriver bit until a large torque causes the spindle 55 to rotate without engagement. This completes the fastening of the screw.

The vibration driver drill 1 according to the present embodiment includes the motor 10, the external gear 76c driven by the motor 10, the planetary gears 84 driven by the external gear 76c, the internal gear 82 meshing with the planetary gears 84, the internal gear lock pins 106 movable forward and rearward relative to the internal gear 82 to lock the internal gear 82 in a nonrotatable manner at a forward position, the spindle 55 driven by the planetary gears 84, the gear housing 52 accommodating the planetary gears 84, the first vibration cam 152 fixed to the spindle 55, the second vibration cam 154 that rubs against the first vibration cam 152 and rotatable relative to the gear housing 52, the vibration switch levers 172 movable forward and rearward relative to the second vibration cam 154 to lock the second vibration cam 154 in a nonrotatable manner at a forward position, and the annular change ring 54 that switches between forward movement and rearward movement of the internal gear lock pins 106 and switches between forward movement and rearward movement of the vibration switch levers 172. The single change ring 54 allows switching of the clutch (movement of the internal gear lock pins 106 between forward and rearward), and switching of vibration (movement of the vibration switch levers 172 between forward and rearward), enabling easy operation.

The vibration driver drill 1 further includes the pin holder 102 holding the internal gear lock pins 106. The support ring 100 connected to the pin holder 102 includes the cam projections 100b (pin holder cams) for moving the internal gear lock pins 106 forward and rearward relative to the internal gear 82 when the change ring 54 is at a predetermined rotational position. Thus, a mechanism for switching the clutch (for moving the internal gear lock pins 106 forward and rearward) is smoothly operable and simple.

Further, the vibration switch levers 172 include the raised portions 172b (vibration switch cams) for moving the vibration switch levers 172 forward and rearward relative to the second vibration cam 154 when the change ring 54 is at a predetermined rotational position. Thus, the vibration driver drill 1 includes a mechanism for switching vibration (for moving the vibration switch levers 172 forward and rearward) that is smoothly operable and simple.

The vibration driver drill 1 according to the present embodiment includes the motor 10, the external gear 76c driven by the motor 10, the planetary gears 84 driven by the external gear 76c, the internal gear 82 meshing with the planetary gears 84, the clutch pin coil springs 92, the clutch pins 96 that come in contact with the internal gear 82 when urged by the clutch pin coil springs 92 to lock the internal gear 82 in a nonrotatable manner in accordance with the urging force of the clutch pin coil springs 92, the spring holder 90 holding the clutch pin coil springs 92 to allow the clutch pin coil springs 92 to generate a variable urging force, the spindle 55 driven by the planetary gears 84, the gear housing 52 accommodating the planetary gears 84, the first vibration cam 152 fixed to the spindle 55, the second vibration cam 154 that rubs against the first vibration cam 152 and rotatable relative to the gear housing 52, the vibration switch levers 172 movable forward and rearward relative to the second vibration cam 154 to lock the second vibration cam 154 in a nonrotatable manner at a forward position, and the annular change ring 54 that switches the urging force of the clutch pin coil springs 92 held by the spring holder 90 and switches between forward movement and rearward movement of the vibration switch levers 172. In the vibration driver drill 1, the single change ring 54 allows switching of the clutch setting torque (the urging force of the clutch pin coil springs 92 held by the spring holder 90) and switching of vibration (movement of the vibration switch levers 172 between forward and rearward), enabling easy operation.

The vibration driver drill 1 further includes the internal gear lock pins 106 movable forward and rearward relative to the internal gear 82 to lock the internal gear 82 in a nonrotatable manner at a forward position, the pin holder 102 holding the internal gear lock pins 106, the drill switch ring 108 that switches between forward movement and rearward movement of the internal gear lock pins 106 relative to the internal gear 82 through the pin holder 102 in response to rotation transmitted from the change ring 54, and the lock lever 89 that enables and disables transmission of the rotation of the change ring 54 to the drill switch ring 108. Thus, a mechanism for switching the clutch setting torque (the urging force of the clutch pin coil springs 92 held by the spring holder 90) is smoothly operable and simple.

The drill switch ring 108 has the lock lever receiving recess 108c. The lock lever 89 is located in the change ring 54 to be receivable in the lock lever receiving recess 108c. The lock lever 89 enters the lock lever receiving recess 108c to enable transmission of the rotation of the change ring 54 to the drill switch ring 108. In the clutch mode, the drill switch ring 108 is disengaged from the change ring 54 to retain the internal gear 82 unlocked. In the switching between the drill mode and the vibration mode, the drill switch ring 108 is engaged with the change ring 54 to integrally rotate to reliably lock the internal gear 82. This simple mechanism allows smooth operation.

The second vibration cam 154 includes the tabs 154c. The vibration switch levers 172 each include the vibration switch tab 172c. The tabs 154c are catchable by the vibration switch tabs 172c to lock the second vibration cam 154 in a nonrotatable manner. Thus, the vibration mechanism is smoothly operable and simple.

The vibration driver drill 1 according to the present embodiment includes the external gear 76c, the planetary gears 84 meshing with the external gear 76c, the internal gear 82 meshing with the planetary gears 84, the spindle 55 connected to the planetary gears 84, the clutch pin coil springs 92 that urge the internal gear 82, the first vibration cam 152 and the second vibration cam 154 that axially vibrate the spindle 55, the internal gear lock pins 106 that lock the internal gear 82 in a nonrotatable manner, and the change ring 54 connected to the clutch pin coil springs 92, the first vibration cam 152 and the second vibration cam 154, and the internal gear lock pins 106.

The single change ring 54 allows the control of the clutch pin coil springs 92, the first vibration cam 152 and the second vibration cam 154, and the internal gear lock pins 106, enabling easy operation.

Embodiments and modifications of the present invention are not limited to the above embodiments and modifications, and may be modified as appropriate as described below.

The recesses and the protrusions on the cam components may be reversed. For example, the vibration switch levers 172 may have the cam recesses 170c, and the vibration switch ring 170 may have the raised portions 172b. Further, the cam components may be driven with parts other than the recesses and the protrusions.

Intermediate components between the components, for example, the support ring 100 between the drill switch ring 108 and the pin holder 102, may be eliminated. Additional intermediate components may be located between the components.

The rotational axis of the change ring 54 may not be coaxial with the spindle 55 (output shaft). The change ring 54 may be replaced with a change lever movable to cause mode switching.

The clutch mechanism 97 may be an electronic clutch. The vibration mechanism 150 may generate vibrations electrically. The vibration mechanism 150 may be eliminated to provide an electric driver drill with no vibration mode. The clutch mechanism 97 may be eliminated to provide a vibration drill with no clutch mode. The drill mode may be eliminated to provide a vibration driver with no drill mode.

The pin holding members 102d may hold the internal gear lock pins 106 in a different manner, such as press fitting of a projection into a hole. The manner for holding or press fitting may be modified as appropriate.

The fan 42 may be arranged in front of the stator 35.

The battery 32 may be a lithium-ion battery of 18 to 36 V including 14.4 V, 18 V (20 V at the maximum), 18 V, 25.2 V, 28 V, and 36 V, or may be a lithium-ion battery of less than 10.8 V or greater than 36 V, or may be another battery. Two or more batteries 32 may be used. Such multiple batteries 32 may be connected either in series or in parallel, or some of the batteries 32 may be connected in series and the others may be connected in parallel.

The gear housing 52 may be held inside the body housing 20.

At least the number of sections in the housing 2, planetary gears, stages of a reduction mechanism, balls in the components, the rollers 130, protrusions on the components (for example, protrusions, protruding pieces, and protruding portions), pins on the components, springs of the components, or screws for the components may be smaller or greater than the number described above. Each component may be formed from another material. For example, the balls may be formed from a resin instead of steel. The type of each operational part, such as the switch type of the switch lever 8, may be changed. Each component or member may be arranged in a different manner. For example, the spring holder 90 in the clutch mechanism 97 may be arranged radially inward from the pin holder 102 for locking the internal gear 82. Each component may have another shape. For example, the follower 89b in the lock lever 89 may be trapezoidal.

The present invention may be applicable to an angle power tool including an output shaft (tip tool holder) in a direction different (about 90 degrees) from the direction of a power unit (at least either the direction of the motor shaft 37 of the motor 10 or the transmission direction of rotation from the motor shaft 37 by a transmission mechanism).

The present invention may be applicable to non-chargeable (non-battery driven) tools powered by utility power including a vibration driver drill, other power tools, a cleaner, a blower, and a gardening tool such as a gardening trimmer.

### REFERENCE SIGNS LIST

1 electric vibration driver drill (power tool)
10 motor
52 gear housing
54 change ring
55 spindle
76c external gear (sun gear)
82 internal gear
84 planetary gear
89 lock lever (locking member)
90 spring holder (elastic member holder)
92 clutch pin coil spring (clutch pin elastic member or elastic member)
96 clutch pin
100 support ring (a member connectable to a pin holder)
100b cam projection (pin holder cam)
102 pin holder
106 internal gear lock pin
108 drill switch ring
108c lock lever receiving recess (locking member receiving recess)
152 first vibration cam (vibration cam)
154 second vibration cam (vibration cam)
154c tab
172 vibration switch lever (vibration switch member)
172b raised portion (vibration switch cam)
172c vibration switch tab

What is claimed is:

1. A power tool, comprising:
a motor;
a sun gear driven by the motor;
a planetary gear driven by the sun gear;
an internal gear meshing with the planetary gear;
an internal gear lock pin movable forward and rearward relative to the internal gear and configured to lock the internal gear in a nonrotatable manner at a forward position;
a spindle driven by the planetary gear;
a gear housing accommodating the planetary gear;
a first vibration cam fixed to the spindle;
a second vibration cam configured to rub against the first vibration cam and rotatable relative to the gear housing;
a vibration switch member movable forward and rearward relative to the second vibration cam and configured to lock the second vibration cam in a nonrotatable manner at a forward position; and
an annular change ring configured to switch between forward movement and rearward movement of the internal gear lock pin and to switch between forward movement and rearward movement of the vibration switch member.

2. The power tool according to claim 1, further comprising:
a pin holder holding the internal gear lock pin; and
a pin holder cam configured to move the internal gear lock pin forward and rearward relative to the internal gear when the change ring is at a predetermined rotational position.

3. The power tool according to claim 2, wherein
the pin holder cam is included in the pin holder or a member connected to the pin holder.

4. The power tool according to claim 1, further comprising:
a vibration switch cam configured to move the vibration switch member forward and rearward relative to the second vibration cam when the change ring is at a predetermined rotational position.

5. The power tool according to claim 4, wherein
the vibration switch cam is included in the vibration switch member or a member connected to the vibration switch member.

6. The power tool according to claim 2, further comprising:
a vibration switch cam configured to move the vibration switch member forward and rearward relative to the second vibration cam when the change ring is at a predetermined rotational position.

7. A power tool, comprising:
a motor;
a sun gear driven by the motor;
a planetary gear driven by the sun gear;
an internal gear meshing with the planetary gear;
a clutch pin elastic member;
a clutch pin configured to come in contact with the internal gear when urged by the clutch pin elastic member to retain the internal gear in a nonrotatable manner in accordance with an urging force of the clutch pin elastic member;
an elastic member holder holding the clutch pin elastic member to allow the clutch pin elastic member to generate a variable urging force;
a spindle driven by the planetary gear;
a gear housing accommodating the planetary gear;
a first vibration cam fixed to the spindle;
a second vibration cam configured to rub against the first vibration cam and rotatable relative to the gear housing;
a vibration switch member movable forward and rearward relative to the second vibration cam and configured to lock the second vibration cam in a nonrotatable manner at a forward position; and
an annular change ring configured to switch the urging force of the clutch pin elastic member held by the elastic member holder and to switch between forward movement and rearward movement of the vibration switch member.

8. The power tool according to claim 7, further comprising:
an internal gear lock pin movable forward and rearward relative to the internal gear and configured to lock the internal gear in a nonrotatable manner at a forward position;
a pin holder holding the internal gear lock pin;
a drill switch ring configured to switch between forward movement and rearward movement of the internal gear lock pin relative to the internal gear through the pin holder in response to rotation transmitted from the change ring; and
a locking member configured to enable and disable transmission of the rotation of the change ring to the drill switch ring.

9. The power tool according to claim 8, wherein
the drill switch ring has a locking member receiving recess,
the locking member is located in the change ring to be receivable in the locking member receiving recess, and
the locking member enters the locking member receiving recess to enable transmission of the rotation of the change ring to the drill switch ring.

10. The power tool according to claim 1, wherein
the second vibration cam includes a tab,
the vibration switch member includes a vibration switch tab, and
the tab is catchable by the vibration switch tab to lock the second vibration cam in a nonrotatable manner.

11. The power tool according to claim 7, wherein
the power tool comprises a plurality of the clutch pin elastic members.

12. The power tool according to claim 10, wherein
the power tool comprises a plurality of the clutch pin elastic members.

13. The power tool according to claim 7, wherein
the second vibration cam includes a tab,
the vibration switch member includes a vibration switch tab, and
the tab is catchable by the vibration switch tab to lock the second vibration cam in a nonrotatable manner.

14. A power tool, comprising:
a sun gear;
a planetary gear meshing with the sun gear;
an internal gear meshing with the planetary gear;
a spindle connected to the planetary gear;
an elastic member configured to urge the internal gear;
vibration cams configured to axially vibrate the spindle;
an internal gear lock pin configured to lock the internal gear in a nonrotatable manner; and
a change ring connected to the elastic member, the vibration cams, and the internal gear lock pin.
